(19) United States
(12) Patent Application Publication
(10) Pub. No.: US 2020/0245135 A1
(43) Pub. Date: Jul. 30, 2020

(54) SUPPORT FOR EARLY DATA TRANSMISSION WITH CENTRAL UNIT/DISTRIBUTED UNIT FUNCTIONAL SPLIT

(71) Applicant: QUALCOMM Incorporated, San Diego, CA (US)

(72) Inventors: Umesh Phuyal, San Diego, CA (US); Soo Bum Lee, San Diego, CA (US); Luis Fernando Brisson Lopes, Swindon (GB); Alberto Rico Alvarino, San Diego, CA (US)

(21) Appl. No.: 16/749,463

(22) Filed: Jan. 22, 2020

Related U.S. Application Data
(60) Provisional application No. 62/797,900, filed on Jan. 28, 2019.

(51) Int. Cl. H04W 12/00; H04W 76/11; H04W 12/06; H04W 76/27; H04L 9/06; H04W 12/10; H04W 12/04

(52) U.S. Cl. CPC H04W 12/0013; H04W 76/11; H04W 12/06; H04W 12/0401; H04L 9/0643; H04W 12/1006; H04W 76/27

(57) ABSTRACT

Methods, systems, and devices for wireless communications are described. A receiving device may receive, at a central unit of the receiving device, information from which the central unit is able to identify a hash calculated based at least in part on a data portion of a message received by a distributed unit of the receiving device. The receiving device may confirm, at the central unit and based at least in part on the hash, an integrity of the data portion of the message. Additionally or alternatively, a distributed unit of the receiving device may confirm the integrity of the data portion of the message. The receiving device may authorize, based at least in part on the integrity confirmation, one or more user plane tunnels with the distributed unit to forward the data portion of the message from the distributed unit to the central unit after processing at the distributed unit.

### CROSS REFERENCE

The present application for patent claims the benefit of U.S. Provisional Patent Application No. 62/797,900 by PHUYAL et al., entitled “SUPPORT FOR EARLY DATA TRANSMISSION WITH CENTRAL UNIT/DISTRIBUTED UNIT FUNCTIONAL SPLIT,” filed Jan. 28, 2019, assigned to the assignee hereof, and expressly incorporated herein.

### BACKGROUND

The following relates generally to wireless communications, and more specifically to support for early data transmission with a central unit/distributed unit functional split.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include a number of base stations or network access nodes, each simultaneously supporting communication for multiple communication devices, which may be otherwise known as user equipment (UE).

Wireless networks may utilize a structured or layered protocol stack during wireless communications. For example, each wireless device may implement multiple functional layers, with each layer managing one or more aspects of the wireless communications being performed by the wireless devices. Conventionally, each layer may be implemented adjacent to a corresponding upper and/or lower layer, such that interactions between each layer occur quickly. However, some wireless network configurations may be implemented in a wireless device having a split layer functionality which in some cases may introduce delays that may negatively impact the wireless transmissions between the wireless devices.

### SUMMARY

The described techniques relate to improved methods, systems, devices, and apparatuses that support early data transmission with a central unit/distributed unit functional split. Generally, the described techniques provide for improved interactions between functional layers within a wireless device, such as a base station and/or a user equipment (UE). Broadly, aspects of the described techniques provide for coordination between the layers in a split functionality configuration to reduce latency, improve security/integrity, increase throughput, and the like.

As one example and with reference to the central unit of a receiving device, aspects of the described techniques may support the central unit performing data integrity verification for a message or for a portion of a message received first at a distributed unit of a receiving device. For example, the distributed unit of the receiving device may receive a message and transmit or otherwise provide information to the central unit that may be used to calculate or otherwise identify a hash. Generally the hash (or hash value) may be calculated based on a data portion of the message. In one example, the distributed unit may calculate and send the hash to the central unit. In another example, the distributed unit may transmit or otherwise provide a bit string (or a byte string or an equivalent) of the data portion of the message to the central unit. In such examples, the central unit may calculate the hash. The central unit may then use the hash (along with other inputs) to confirm the integrity of the data portion of the message. For example, the central unit may confirm that control information (e.g., which may also be referred to as a ShortResumeMAC-I message authentication token, or sRMAC-I) carried in a control portion of the message matches control information calculated based at least in part on the hash (along with the other inputs). Upon data integrity confirmation, the central unit may authorize user plane tunnel(s) with the distributed unit, and the distributed unit may forward the data portion of the message after the distributed unit processes the message.

As another example and with reference to the distributed unit of the receiving device, aspects of the described techniques may support the distributed unit performing the data integrity verification. For example, the distributed unit may obtain or otherwise identify the control information (e.g., the sRMAC-I) that is carried or otherwise conveyed in the control portion of the message. The distributed unit may obtain or otherwise identify the control information by performing a deep packet inspection of the message (e.g., by decoding the control portion of the message) and/or by providing the control portion of the message to the central unit to receive the identification of control information from the central unit. The distributed unit may determine the hash based on the data portion of the message and may confirm the data integrity based on the hash, the control information, and other inputs. The distributed unit may establish user plane tunnel(s) with the central unit(s) to forward the message after processing.

A method of wireless communications at a receiving device is described. The method may include receiving, at a central unit of the receiving device, information from which the central unit is able to identify a hash calculated based on a data portion of a message received by a distributed unit of the receiving device, confirming, at the central unit and based on the hash, an integrity of the data portion of the message, and authorizing, based on the integrity confirmation, one or more user plane tunnels with the distributed unit to forward the data portion of the message from the distributed unit to the central unit after processing at the distributed unit.

An apparatus for wireless communications at a receiving device is described. The apparatus may include a processor, memory in electronic communication with the processor, and instructions stored in the memory. The instructions may be executable by the processor to cause the apparatus to receive, at a central unit of the receiving device, information from which the central unit is able to identify a hash calculated based on a data portion of a message received by a distributed unit of the receiving device, confirm, at the central unit and based on the hash, an integrity of the data portion of the message, and authorize, based on the integrity confirmation, one or more user plane tunnels with the distributed unit to forward the data portion of the message from the distributed unit to the central unit after processing at the distributed unit.

Another apparatus for wireless communications at a receiving device is described. The apparatus may include means for receiving, at a central unit of the receiving device, information from which the central unit is able to identify a hash calculated based on a data portion of a message received by a distributed unit of the receiving device, confirming, at the central unit and based on the hash, an integrity of the data portion of the message, and authorizing, based on the integrity confirmation, one or more user plane tunnels with the distributed unit to forward the data portion of the message from the distributed unit to the central unit after processing at the distributed unit.

A non-transitory computer-readable medium storing code for wireless communications at a receiving device is described. The code may include instructions executable by a processor to receive, at a central unit of the receiving device, information from which the central unit is able to identify a hash calculated based on a data portion of a message received by a distributed unit of the receiving device, confirm, at the central unit and based on the hash, an integrity of the data portion of the message, and authorize, based on the integrity confirmation, one or more user plane tunnels with the distributed unit to forward the data portion of the message from the distributed unit to the central unit after processing at the distributed unit.

In some examples of the method, apparatuses, and non-transitory computer-readable medium described herein, confirming the integrity of the data portion may include operations, features, means, or instructions for confirming that a first control information from a control portion of the message matches a second control information calculated based on the hash.

In some examples of the method, apparatuses, and non-transitory computer-readable medium described herein, authorizing the one or more user plane tunnels may include operations, features, means, or instructions for establishing the one or more user plane tunnels.

In some examples of the method, apparatuses, and non-transitory computer-readable medium described herein, authorizing the one or more user plane tunnels may include operations, features, means, or instructions for identifying the one or more user plane tunnels are previously established.

In some examples of the method, apparatuses, and non-transitory computer-readable medium described herein, the first and second control information include a ShortResumeMAC-I message authentication token.

In some examples of the method, apparatuses, and non-transitory computer-readable medium described herein, the information identifies the hash calculated by the distributed unit.

In some examples of the method, apparatuses, and non-transitory computer-readable medium described herein, the information may include operations, features, means, or instructions for calculating the hash based on the bit string.

Some examples of the method, apparatuses, and non-transitory computer-readable medium described herein may further include operations, features, means, or instructions for receiving a control portion and the data portion of the message from the distributed unit, and identifying a control information from the control portion of the message, where the integrity of the data portion may be confirmed based on the control information.

In some examples of the method, apparatuses, and non-transitory computer-readable medium described herein, the control portion and the data portion of the message may be received at a control plane function of the central unit.

In some examples of the method, apparatuses, and non-transitory computer-readable medium described herein, the receiving device may include operations, features, means, or instructions for providing, to a source base station associated with a wireless device transmitting the message, the hash and a control information from a control portion of the message, and receiving a signal from the source base station confirming the integrity of the data portion of the message.

Some examples of the method, apparatuses, and non-transitory computer-readable medium described herein may further include operations, features, means, or instructions for receiving a security context for the wireless device from the source base station, and establishing a security protocol with the wireless device based on the security context.

Some examples of the method, apparatuses, and non-transitory computer-readable medium described herein may further include operations, features, means, or instructions for forwarding the data portion of the message to a network entity after processing at the central unit.

Some examples of the method, apparatuses, and non-transitory computer-readable medium described herein may further include operations, features, means, or instructions for identifying at least one of a radio resource control (RRC) key, a physical layer cell identifier (PCI), a source base station cellular radio network temporary identifier (C-RNTI), a resume constant value, a cell identifier for the receiving device, or a combination thereof, used for confirming the integrity of the data portion.

A method of wireless communications at a receiving device is described. The method may include receiving a message at a distributed unit of the receiving device, identifying, at a distributed unit of the receiving device, control information from a control portion of a message received by the distributed unit of the receiving device, determining a hash calculated based on a data portion of the message, confirming, at the distributed unit and based on the hash and the control information, an integrity of the data portion of the message, and authorizing, based on the integrity confirmation, one or more user plane tunnels with one or more central units of the receiving device to forward the data portion of the message from the distributed unit to the central unit after processing at the distributed unit.

An apparatus for wireless communications at a receiving device is described. The apparatus may include a processor, memory in electronic communication with the processor, and instructions stored in the memory. The instructions may be executable by the processor to cause the apparatus to receive a message at a distributed unit of the receiving device, identify, at a distributed unit of the receiving device, control information from a control portion of a message received by the distributed unit of the receiving device, determine a hash calculated based on a data portion of the message, confirm, at the distributed unit and based on the hash and the control information, an integrity of the data portion of the message, and authorize, based on the integrity confirmation, one or more user plane tunnels with one or more central units of the receiving device to forward the data portion of the message from the distributed unit to the central unit after processing at the distributed unit.

Another apparatus for wireless communications at a receiving device is described. The apparatus may include means for receiving a message at a distributed unit of the receiving device, identifying, at a distributed unit of the receiving device, control information from a control portion of a message received by the distributed unit of the receiving device, determining a hash calculated based on a data portion of the message, confirming, at the distributed unit and based on the hash and the control information, an integrity of the data portion of the message, and authorizing, based on the integrity confirmation, one or more user plane tunnels with one or more central units of the receiving device to forward the data portion of the message from the distributed unit to the central unit after processing at the distributed unit.

A non-transitory computer-readable medium storing code for wireless communications at a receiving device is described. The code may include instructions executable by a processor to receive a message at a distributed unit of the receiving device, identify, at a distributed unit of the receiving device, control information from a control portion of a message received by the distributed unit of the receiving device, determine a hash calculated based on a data portion of the message, confirm, at the distributed unit and based on the hash and the control information, an integrity of the data portion of the message, and authorize, based on the integrity confirmation, one or more user plane tunnels with one or more central units of the receiving device to forward the data portion of the message from the distributed unit to the central unit after processing at the distributed unit.

In some examples of the method, apparatuses, and non-transitory computer-readable medium described herein, confirming the integrity of the data message may include operations, features, means, or instructions for receiving, from the central unit of the receiving device, a key, and using the key and the hash to verify the control information from the control portion of the message, where verifying the control information confirms the integrity of the data portion of the message.

In some examples of the method, apparatuses, and non-transitory computer-readable medium described herein, authorizing the one or more user plane tunnels may include operations, features, means, or instructions for establishing the one or more user plane tunnels.

In some examples of the method, apparatuses, and non-transitory computer-readable medium described herein, authorizing the one or more user plane tunnels may include operations, features, means, or instructions for identifying the one or more user plane tunnels are previously established

In some examples of the method, apparatuses, and non-transitory computer-readable medium described herein, the key may be calculated by the central unit and may be unique to the distributed unit.

In some examples of the method, apparatuses, and non-transitory computer-readable medium described herein, the key may be a source base station key that may be common to the central unit and the distributed unit.

In some examples of the method, apparatuses, and non-transitory computer-readable medium described herein, identifying the control information may include operations, features, means, or instructions for decoding the control portion of the message.

In some examples of the method, apparatuses, and non-transitory computer-readable medium described herein, identifying the control information may include operations, features, means, or instructions for transmitting the control portion of the message to the central unit, and receiving a signal from the central unit identifying the control information.

In some examples of the method, apparatuses, and non-transitory computer-readable medium described herein, confirming the integrity of the data portion may include operations, features, means, or instructions for confirming that the control information from the control portion of the message matches a calculated control information, the calculated control information being calculated based on the hash.

In some examples of the method, apparatuses, and non-transitory computer-readable medium described herein, the control information and the calculated control information include a ShortResumeMAC-I message authentication token.

In some examples of the method, apparatuses, and non-transitory computer-readable medium described herein, the receiving device may include operations, features, means, or instructions for providing, from the central unit and to a source base station associated with a wireless device transmitting the message, the hash and the control information from the control portion of the message, and receiving, at the central unit and from the source base station, a signal confirming the integrity of the data portion of the message.

Some examples of the method, apparatuses, and non-transitory computer-readable medium described herein may further include operations, features, means, or instructions for forwarding the data portion of the message to at least one of the one or more central units, a network entity, or a combination thereof, after processing at the distributed unit.

Some examples of the method, apparatuses, and non-transitory computer-readable medium described herein may further include operations, features, means, or instructions for identifying at least one of a RRC key, a PCI, a source base station C-RNTI, a resume constant value, a cell identifier for the receiving device, or a combination thereof, used for confirming the integrity of the data portion.

### BRIEF DESCRIPTION OF THE DRAWINGS

FIG. 1 illustrates an example of a system for wireless communications that provides support for early data transmission with a central unit/distributed unit functional split in accordance with aspects of the present disclosure.

FIG. 2 illustrates an example of a protocol stack that provides support for early data transmission with a central unit/distributed unit functional split in accordance with aspects of the present disclosure.

FIG. 3 illustrates an example of a wireless communication system that provides support for early data transmission with a central unit/distributed unit functional split in accordance with aspects of the present disclosure.

FIG. 4 illustrates an example of a process that provides support for early data transmission with a central unit/distributed unit functional split in accordance with aspects of the present disclosure.

FIG. 5 illustrates an example of a process that provides support for early data transmission with a central unit/distributed unit functional split in accordance with aspects of the present disclosure.

FIGS. 6 and 7 show block diagrams of devices that support early data transmission with a central unit/distributed unit functional split in accordance with aspects of the present disclosure.

FIG. 8 shows a block diagram of a communications manager that provides support for early data transmission with a central unit/distributed unit functional split in accordance with aspects of the present disclosure.

FIG. 9 shows a diagram of a system including a user equipment (UE) that provides support for early data transmission with a central unit/distributed unit functional split in accordance with aspects of the present disclosure.

FIG. 10 shows a diagram of a system including a base station that provides support for early data transmission with a central unit/distributed unit functional split in accordance with aspects of the present disclosure.

FIGS. 11 through 13 show flowcharts illustrating methods that support early data transmission with a central unit/distributed unit functional split in accordance with aspects of the present disclosure.

### DETAILED DESCRIPTION

Wireless network configurations are updated continuously in order to reduce latency, improve reliability, increase throughput, improve security/integrity, and the like. Such networks may use various transmission schemes to support communications between a user equipment (UE) and base station. In some examples, the transmission schemes may support uplink transmissions based, at least in some aspects, on a random access procedure. For example, some transmission schemes may support a four-step uplink random access procedure that allows data transmission in message five (Msg5) of the random access procedure. Another transmission scheme may support early data transmission (EDT), which generally utilizes a two-step uplink access procedure that allows data transmission in message three (Msg3) of the random access procedure. Yet another transmission scheme may support uplink data transmissions in message one (Msg1) of the random access procedure and using configured resources.

Wireless networks may also utilize a structured or layered protocol stack during such wireless communications. For example, each wireless device may implement multiple functional layers, with each layer managing one or more aspects of the wireless communications being performed by the wireless devices. Conventionally, each layer is implemented immediately adjacent to the corresponding upper and/or lower layer, such that interactions between each layer occur quickly. However, some wireless network configurations may be implemented in a wireless device having a split layer functionality. For example, a base station may have a functional split between the protocol layers, with one or more central units of the base station generally performing higher layer functionality and one or more distributed units of the base station performing lower layer functionality.

For example, a central unit may be associated with various base station functions such as transfer of user data, mobility control, session management, network sharing applications, mobility control, etc. In addition, a central unit may in some cases control the operation of distributed units over various network interfaces. A distributed unit, in some examples, may be associated with an additional subset of base station functions. The distributed unit may be controlled in part by the central unit, and functionality of the distributed unit may be based on aspects of the functional split.

In the case of the UE, the functional split may be based on different components (or components from different manufacturers), processes, functions, and the like, implementing different layer functionality. For example, a first component of the UE may function (and therefore be considered as) similar to the central unit, with a second component of the UE functioning (and therefore being considered as) the distributed unit. While there may be advantages with such a functional split between the protocol layers of the wireless device, this may introduce delays or otherwise limit interactions between each functional layer. Such delays may negatively impact the wireless transmissions between the wireless devices.

Aspects of the disclosure are initially described in the context of a wireless communications system. Generally, the described techniques provide for improved interactions between functional layers within a wireless device, such as a base station and/or a UE. Broadly, aspects of the described techniques provide for coordination between the layers in a split functionality configuration to reduce latency, improve security/integrity, increase throughput, and the like. Aspects of the techniques are described with reference to a receiving device, which may be a base station and/or a UE. Aspects of the techniques are also described with reference to a central unit and a distributed unit of the receiving device, with the central unit generally referring to the functionality being performed at the higher layers of the protocol stack and the distributed unit generally referring to the functionality being performed at the lower layers of the protocol stack. Aspects of the described techniques may support any functional split between the protocol layers. That is, the described techniques are not limited to any particular protocol layer split configuration.

As one example and with reference to the central unit of the receiving device, aspects of the described techniques may support the central unit performing the data integrity verification. For example, the distributed unit of the receiving device may receive a message and may transmit or otherwise provide information to the central unit that may be used to identify a hash. Generally the hash (or hash value) may be calculated, or otherwise based at least in part on the data portion of the message. In one example, the distributed unit may calculate and send the hash to the central unit. In another example, the distributed unit may transmit or otherwise provide a bit string (or byte string or equivalent) corresponding to, or otherwise associated with, the data portion of the message. In that example, the central unit may calculate the hash. The central unit may then use the hash (among other inputs) to confirm the integrity of the data portion of the message. For example, the central unit may confirm that control information (e.g., which may also be referred to as a ShortResumeMAC-I message authentication token, or simply sRMAC-I) carried in a control portion of the message matches control information calculated based at least in part on the hash (along with other inputs). Upon data integrity confirmation, the central unit may authorize user plane tunnel(s) with the distributed unit to forward the data portion of the message from the distributed unit to the central unit after the distributed unit processes the message.

As another example and with reference to the distributed unit of the receiving device, aspects of the described techniques may support the distributed unit performing the data integrity verification for message. For example, the distributed unit may obtain or otherwise identify the control information (e.g., such as the ShortResumeMAC-I message authentication token) that is carried or otherwise conveyed in the control portion of the message. The distributed unit may obtain or otherwise identify the control information by performing a deep packet inspection of the message (e.g., by decoding the control portion of the message) and/or by providing the control portion of the message to the central unit in order to receive the identification of control information from the central unit. The distributed unit may determine the hash based on the data portion of the message and then may confirm the data integrity based on the hash and/or the control information. The distributed unit may establish user plane tunnel(s) with the central unit(s) (or may use a previously established user plane tunnel) to forward the message after processing.

Aspects of the disclosure are further illustrated by and described with reference to apparatus diagrams, system diagrams, and flowcharts that relate to support for early data transmission with central unit/distributed unit functional split.

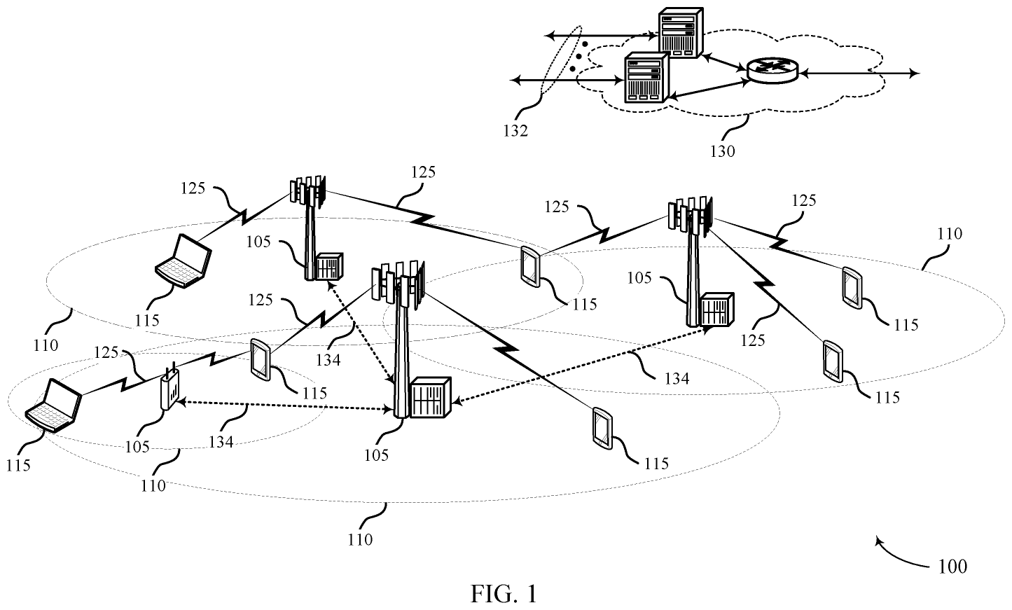

FIG. 1 illustrates an example of a wireless communications system 100 that provides support for early data transmission with a central unit/distributed unit functional split in accordance with aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links 134 (e.g., via an X2, Xn, or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that may be capable of tolerating interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, base station 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving device is equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may use multiple antennas or antenna arrays to conduct beamforming operations for directional communications with a UE 115. For instance, some signals (e.g., synchronization signals, reference signals, beam selection signals, or other control signals) may be transmitted by a base station 105 multiple times in different directions, which may include a signal being transmitted according to different beamforming weight sets associated with different directions of transmission. Transmissions in different beam directions may be used to identify (e.g., by the base station 105 or a receiving device, such as a UE 115) a beam direction for subsequent transmission and/or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based at least in in part on a signal that was transmitted in different beam directions. For example, a UE 115 may receive one or more of the signals transmitted by the base station 105 in different directions, and the UE 115 may report to the base station 105 an indication of the signal it received with a highest signal quality, or an otherwise acceptable signal quality. Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115), or transmitting a signal in a single direction (e.g., for transmitting data to a receiving device).

A receiving device (e.g., a UE 115, which may be an example of a mmW receiving device) may try multiple receive beams when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions. In some examples a receiving device may use a single receive beam to receive along a single beam direction (e.g., when receiving a data signal). The single receive beam may be aligned in a beam direction determined based at least in part on listening according to different receive beam directions (e.g., a beam direction determined to have a highest signal strength, highest signal-to-noise ratio, or otherwise acceptable signal quality based at least in part on listening according to multiple beam directions).

In some cases, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use hybrid automatic repeat request (HARD) to provide retransmission at the MAC layer to improve link efficiency. In the control plane, the radio resource control (RRC) protocol layer may provide establishment, configuration, and maintenance of an RRC connection between a UE 115 and a base station 105 or core network 130 supporting radio bearers for user plane data. At the Physical layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Tₛ=1/30,720,000 seconds. Time intervals of a communications resource may be organized according to radio frames each having a duration of 10 milliseconds (ms), where the frame period may be expressed as T_{f}=307,200 Ts. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases, a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a base station 105.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an evolved universal mobile telecommunication system terrestrial radio access (E-UTRA) absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as orthogonal frequency division multiplexing (OFDM) or discrete Fourier transform spread OFDM (DFT-S-OFDM)).

The organizational structure of the carriers may be different for different radio access technologies (e.g., LTE, LTE-A, LTE-A Pro, NR). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth, or may be configurable to support communications over one of a set of carrier bandwidths. In some examples, the wireless communications system 100 may include base stations 105 and/or UEs 115 that support simultaneous communications via carriers associated with more than one different carrier bandwidth.

Wireless communications system 100 may support communication with a UE 115 on multiple cells or carriers, a feature which may be referred to as carrier aggregation or multi-carrier operation. A UE 115 may be configured with multiple downlink component carriers and one or more uplink component carriers according to a carrier aggregation configuration. Carrier aggregation may be used with both FDD and TDD component carriers.

In some cases, wireless communications system 100 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In some cases, an eCC may utilize a different symbol duration than other component carriers, which may include use of a reduced symbol duration as compared with symbol durations of the other component carriers. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may consist of one or multiple symbol periods. In some cases, the TTI duration (that is, the number of symbol periods in a TTI) may be variable.

Wireless communications system 100 may be an NR system that may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across the frequency domain) and horizontal (e.g., across the time domain) sharing of resources.

A receiving device (which may be an example of a base station 105 and/or a UE 115) may receive, at a central unit of the receiving device, information from which the central unit is able to identify a hash calculated based at least in part on a data portion of a message received by a distributed unit of the receiving device. The receiving device may confirm, at the central unit and based at least in part on the hash, an integrity of the data portion of the message. The receiving device may authorize, based at least in part on the integrity confirmation, one or more user plane tunnels with the distributed unit to forward the data portion of the message from the distributed unit to the central unit after processing at the distributed unit.

A receiving device (which may be an example of a base station 105 and/or a UE 115) may receive a message at a distributed unit of the receiving device, identify, at a distributed unit of the receiving device, control information from a control portion of a message received by the distributed unit of the receiving device. The receiving device may determine a hash calculated based at least in part on a data portion of the message. The receiving device may confirm, based at least in part on the hash and the control information, an integrity of the data portion of the message. The receiving device may authorize, based at least in part on the integrity confirmation, one or more user plane tunnels with one or more central units of the receiving device to forward the data portion of the message from the distributed unit to the central unit after processing at the distributed unit.

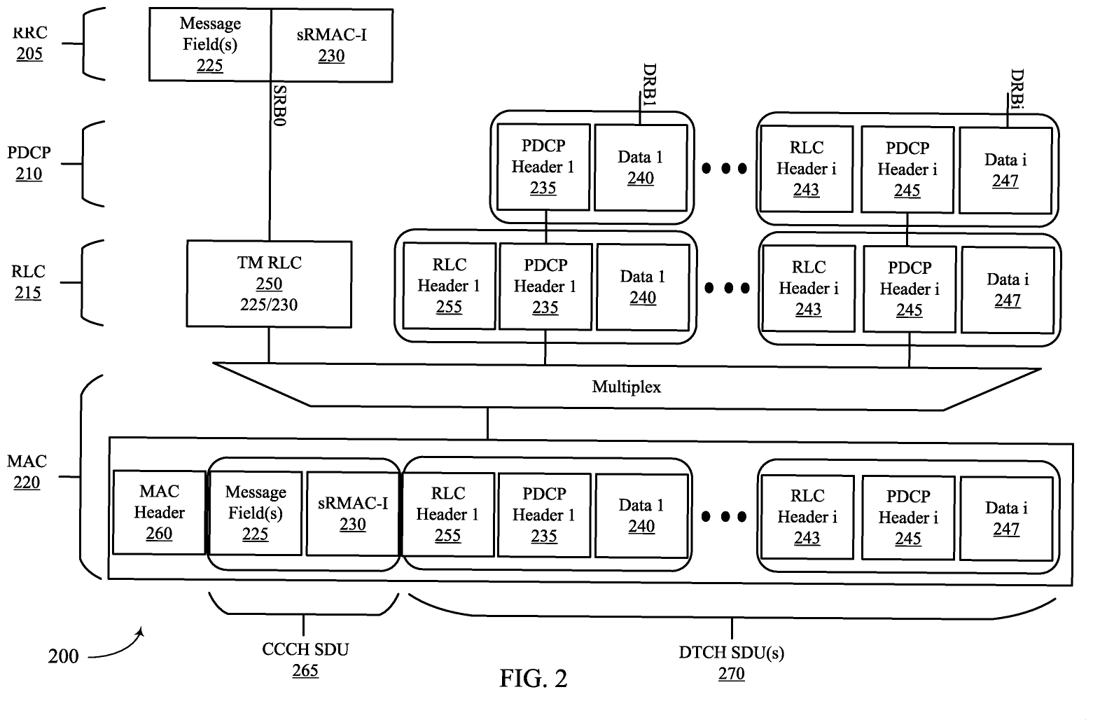

FIG. 2 illustrates an example of a protocol stack 200 that provides support for early data transmission with a central unit/distributed unit functional split in accordance with aspects of the present disclosure. In some examples, protocol stack 200 may implement aspects of wireless communication system 100. Aspects of protocol stack 200 may be implemented by a base station and/or a UE, which may be examples of corresponding devices described herein.

Protocol stack 200 may include a plurality of layers, with each layer performing a different function for wireless transmissions. For example, protocol stack 200 includes an RRC layer 205, the PDCP layer 210, an RLC layer 215, and the MAC layer 220. It is to be understood that more or fewer layers may be implemented for wireless communications in protocol stack 200. For example, the wireless device may also implement a physical layer, an IP layer, and the like, to support wireless communications.

Generally, protocol stack 200 may support wireless communications between a base station and the UE, between base stations, between UEs, and the like. A transmitting device may utilize aspects of protocol stack 200 to package and transmit a message to a receiving device. The transmitting device may be a base station transmitting to a UE in downlink communications or a UE transmitting to a base station in uplink communications. The UE may be the receiving device in the downlink scenario, with the base station being the receiving device and the uplink scenario. However, it is to be understood that the described techniques are not limited to traditional uplink/downlink transmissions and, in some examples may be utilized in D2D communications, inter-base station communications, access and/or backhaul communications, and the like.

As discussed, each layer within protocol stack 200 may perform a different function in packaging or otherwise preparing a message for transmission on the transmitting device side and/or for message reception and recovery on the receiving device side. Broadly, the functions performed within the layers of protocol stack 200 will be described with reference to a Msg3 MAC PDU by way of example only. However, it is to be understood that the functions performed by the layers of protocol stack 200 may be implemented for any message type, such as uplink messages, downlink messages, data messages, control messages, and the like.

In some aspects, the layers within protocol stack 200 can be divided into a layer 3 (L3), a layer 2 (L2), and a layer 1 (L1) (not shown). L1 is the lowest layer and implements various physical layer signal processing functions. L2 is above the L1 and is responsible for the link between the UE and or base station over the physical layer.

In the user plane, L2 includes the MAC layer 220, a RLC layer 215, and a PDCP layer 210, which are terminated at the network device on the network side. Although not shown, the UE may have several upper layers above the L2 including a network layer (e.g., IP layer) that may be terminated at a PDN gateway on the network side, and an application layer that is terminated at the other end of the connection (e.g., far end UE, server, etc.).

The PDCP layer 210 provides multiplexing between different radio bearers and logical channels. The PDCP layer 210 also provides header compression for upper layer data packets to reduce radio transmission overhead, security by ciphering the data packets, and handover support for UEs between network devices or base stations. The RLC layer 215 provides segmentation and reassembly of upper layer data packets, retransmission of lost data packets, and reordering of data packets to compensate for out-of-order reception due to HARQ. The RLC layer 215 passes data to the MAC layer 220 as logical channels.

Generally, a logical channel defines what type of information is being transmitted over the air interface (e.g., user traffic, control channels, broadcast information, etc.). In some aspects, two or more logical channels may be combined into a logical channel group (LCG). By comparison, the transport channel defines how information is transmitted over the air interface (e.g., encoding, interleaving, etc.) and the physical channel defines where information is being transmitted over the air interface (e.g., which symbols of the slot, subframe, fame, etc., are carrying the information).

Logical control channels may include a broadcast control channel (BCCH), which is the downlink channel for broadcasting system control information, a paging control channel (PCCH), which is the downlink channel that transfers paging information, a multicast control channel (MCCH), which is a point-to-multipoint downlink channel used for transmitting multimedia broadcast and multicast service (MBMS) scheduling and control information for one or several multicast traffic channels (MTCHs). Generally, after establishing RRC connection, MCCH is only used by the UEs that receive MBMS. Dedicated control channel (DCCH) is another logical control channel that is a point-to-point bi-directional channel transmitting dedicated control information, such as user-specific control information used by the UE(s) having an RRC connection. Common control channel (CCCH) is also a logical control channel that may be used for random access information. Logical traffic channels may comprise a dedicated traffic channel (DTCH), which is a point-to-point bi-directional channel dedicated to one UE for the transfer of user information. Also, a MTCH may be used for point-to-multipoint downlink transmission of traffic data. In some aspects, each logical channel (or LCG) may have an associated identifier.

The MAC layer 220 generally may manage aspects of the mapping between a logical channel and a transport channel, multiplexing of MAC service data units (SDUs) from logical channel(s) onto the transport block (TB) to be delivered to L1 on transport channels, HARQ based error correction, and the like. The MAC layer 220 may also allocate the various radio resources (e.g., resource blocks) in one cell among the UEs (at the network side). The MAC layer 220 is also responsible for HARQ operations. The MAC layer 220 formats and sends the logical channel data to the physical layer (e.g., L1) as transport channels in one or more TBs.

In the control plane, the radio protocol architecture for the UE and base station is substantially the same for the L1 and the L2, with the exception that there is no header compression function for the control plane. The control plane also includes an RRC layer 205 in L3. The RRC layer 205 is responsible for obtaining radio resources (i.e., radio bearers) and for configuring the lower layers using RRC signaling between the base station and the UE. The RRC layer 205 may also manage one or more aspects of security and/or integrity verification.

Accordingly, the message generated by protocol stack 200 may include various portions. For example, on the control plane, RRC layer 205 may contribute one or more message fields 225 and a short resume MAC-I message authentication token (e.g., ShortResumeMAC-I or sRMAC-I 230). Collectively, the one or more message fields 225 and sRMAC-I 230 may be considered an RRC message and/or a control portion of a message. RLC layer 215 may provide a transport mode (TM) RLC 250 to the message. On the user plane side, PDCP layer 210 may contribute a PDCP header to the data portion of each data radio bearer (DRB). For example, PDCP header 1 235 may correspond to Data 1 240 for DRB1 and PDCP header i 245 may correspond to Data i 247 for DRB i. RLC layer 215 may add RLC headers to PDCP PDU(s) as illustrated by an RLC header 1 255 to the PDCP header 1 235, Data 1 240, RLC header i 243 to PDCP header i 245, Data I 247, and so on.

At the MAC layer 220, the control plane information and the user plane information are multiplexed to create the message for transmission. Additionally, the MAC layer 220 may add a MAC header 260 to the other components of the message. Thus, the finished message for transmission may include a control portion and a data portion. Broadly, the control portion may include one or more parts of the CCH SDU 265, with the data portion including one or more parts of the DTCH SDU 270.

On the receive side, the receiving device may receive the message and performs the reverse operation as information is passed from L1 to L2, L2 to L3, and so on. For example, MAC layer 220 may demultiplex the message and remove the MAC header 260. The MAC layer 220 may pass control plane information (such as the one or more message fields 225 and/or sRMAC-I 230) and the user plane information (such as the RLC header 255, PDCP header 235, and so forth) up protocol stack 200 for additional processing.

One processing function conventionally performed by protocol stack 200 may relate to security and integrity verification. Conventionally, integrity protection may include using a hash that is calculated based on the data carried or otherwise conveyed in the message. For example, on the transmitting device side, the transmitter may calculate the control information (e.g., sRMAC-I 230) based on a hash of the data, in combination with one or more other inputs. The hash is generally calculated based on the contents of the MAC SDU, e.g., MAC layer 220 needs to be aware of and interact with RRC layer 205 due to the involvement of sRMAC-I 230 and the hash of the MAC SDUs. Accordingly, a receiving device can only verify the integrity of the data received in a message using, at least, the hash and the sRMAC-I 230.

However, some wireless networks may support a split architecture where one or more of the layers of protocol stack 200 are implemented independently (at least to some degree) from the other layers of protocol stack 200. As one non-limiting example, a receiving device (and the transmitting device) may include or otherwise utilize one or more central units along with one or more distributed units. For example, the central unit may include a control plane central unit (CP-CU) and one or more user plane central units (UP-CU(s)). In some aspects, the central unit may implement higher layer functionality (e.g., functionality from L3 and, in some examples, L2 functionality) such as RRC layer 205, an IP layer, and the like, with the distributed unit implementing lower layer functionality (e.g., functionality from L2 and, in some examples, L1 functionality). Generally, there may be an interface between the one or more central units and one or more distributed units, e.g., to support signaling transport, data transport, to allow the exchange of control plane information and/or user plane information, and the like.

In some aspects, the central unit/distributed unit functional split described herein may be implemented by a base station. However, it is to be understood that the described techniques are not limited to implementation on a base station but may be implemented by a UE or other device that supports a functional split configuration. For example, the UE may include or otherwise be configured such that one or more functions similar to the central unit are performed in a separate component, process, protocol, and the like, as the functions performed similar to a distributed unit. Accordingly, references to a receiving device according to the described techniques may refer to a UE and/or a base station that is configured with the functional split between one or more layers of protocol stack 200.

In some aspects, the functional split architecture may create or otherwise introduce difficulties with one or more functions performed by protocol stack 200. For example, a message (such as a Msg3 MAC protocol data unit (PDU)) may include the MAC header 260 and one or more message fields 225 that are multiplexed with a data portion (e.g., uplink EDT data) from one or more DRBs. The hash used for integrity protection is generally calculated or otherwise derived based at least in part on the data portion (e.g., the uplink EDT data). This means that the sRMAC-I 230 depends on the data payload, although the sRMAC-I 230 is included (or added) in the RRC message at the RRC layer 205. This requires interaction between the RRC layer 205 and the MAC layer 220 for calculation of the sRMAC-I 230, because only the MAC layer 220 may know the final data payload that fits into the MAC PDU, but the RRC layer 205 needs the hash for calculation of the sRMAC-I 230.

On the receiver side, a MAC layer 220 can calculate the hash based on the received data (e.g., MAC PDU excluding MAC header 260 and message fields 225), while the upper layers may not be able to calculate the hash if the headers are already stripped out of the message at the time of reception at upper layers. However, the RRC message (e.g., the control portion of the message, which may also be referred to as the CCH SDU 265) is transparent to the MAC layer 220 in conventional wireless networks. Instead, the control portion is forwarded on to the RRC layer 205 for further processing during conventional processing.

In a functional split architecture, the RRC layer 205 may be implemented at the central unit, while the MAC layer 220 may be implemented at a distributed unit. Additionally, the central unit may be logically separated into user plane and control plane sides. It is to be understood that references to a central unit may refer to the user plane central unit and/or the control plane central unit. Conventional techniques are further problematic because different DRBs may be processed by different user plane entities at the receiving device. Moreover, the entity that verifies the sRMAC-I 230 according to the calculated hash also may know other inputs, such as a key (e.g., K_{RRcint}), in order to confirm the integrity of the data.

Accordingly, aspects of the described techniques may be implemented in a functional split architecture that includes a central unit and a distributed unit implemented on the receiving device. In one example, the central unit may verify the integrity of the data in the message by identifying the hash, and using the hash along with the sRMAC-I 230 to confirm the integrity of the data portion of the message. The central unit may identify the hash based on information received from the distributed unit (e.g., the distributed unit may receive the message and forward information to the central unit). In one example, the distributed unit may calculate the hash and forward the hash to the central unit. In another example, the distributed unit forward a bit string (or a byte string or an equivalent) of the data to the central unit, with the central unit using the bit string (or byte string or equivalent) to calculate the hash itself. The central unit may use the hash, along with other inputs, to confirm the integrity of the data. For example, the central unit may calculate an sRMAC-I and may confirm that the calculated sRMAC-I matches the sRMAC-I 230 included in the message. Once the integrity of the data is confirmed, the central unit may establish user plane tunnel(s) with the distributed unit to forward the message.

In another example, the distributed unit may verify the integrity of the data. For example, the distributed unit may identify control information in the message (e.g., the sRMAC-I 230) and use the control information, along with the hash and other inputs, to confirm the data integrity. In one example, the distributed unit may perform a deep packet inspection to identify the control information (e.g., the distributed unit may decode the control portion of the message). In another example, the distributed unit may transmit or otherwise provide the RRC message to the central unit (e.g., the distributed unit may transmit the control portion of the message to the central unit). In this example, the central unit may recover the control information (e.g., the sRMAC-I 230) and send this information back down to the distributed unit. The distributed unit may then determine the hash and use the hash, the control information (e.g., the sRMAC-I 230), along with other inputs, to confirm integrity of the data. Once confirmed, the distributed unit may establish user plane tunnel(s) with one or more central units to forward the data after processing.

Accordingly, aspects of the described techniques may support data integrity verification being performed at the central unit or at the distributed unit in a functional split architecture receiving device.

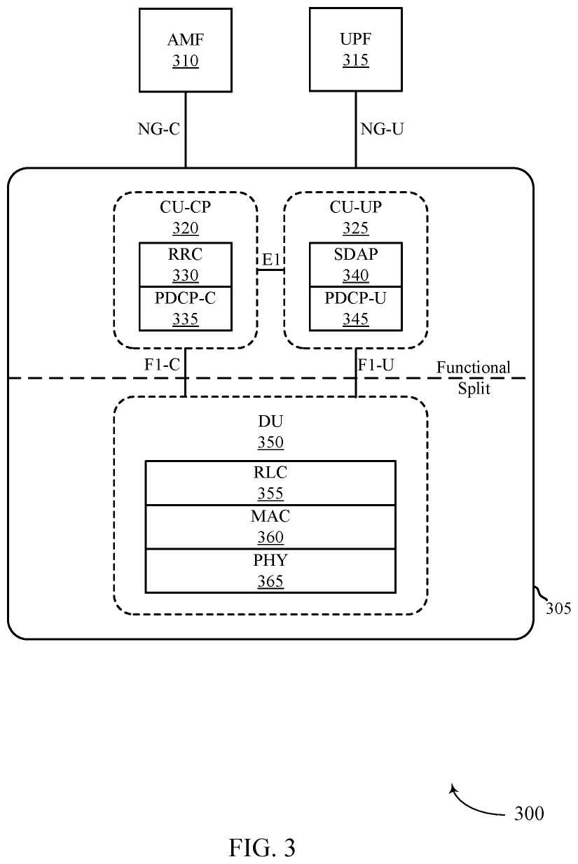

FIG. 3 illustrates an example of a wireless communication system 300 that provides support for early data transmission with a central unit/distributed unit functional split in accordance with aspects of the present disclosure. In some examples, wireless communication system 300 may implement aspects of wireless communication system 100 and/or protocol stack 200. Aspects of wireless communication system 300 may be implemented a by a receiving device 305, an access and mobility management function (AMF) 310, and/or a user plane function (UPF) 315, which may be examples of corresponding devices described herein. For example, a receiving device 305 may be an example of a base station and/or a UE, which may be examples of the corresponding devices described herein.

In some aspects, AMF 310 and UPF 315 may be components of a core network, such as core network 130 discussed herein. The receiving device 305 may communicate with AMF 310 and/or UPF 315 via an NG interface. For example, a receiving device 305 may communicate with AMF 310 via an NG interface in the control plane (NG-C) and with UPF 315 via an NG interface in the user plane (NG-U). Broadly, AMF 310 may monitor, control, and/or otherwise manage one or more aspects of termination of the radio access network (RAN) control plane interface, termination of network access stratum (NAS) interface for NAS ciphering and integrity protection, mobility management, connection management, and the like, within the core network and for receiving device 305. UPF 315 may monitor, control, or otherwise manage one or more aspects of packet routing and forwarding, packet inspection, quality of service handling for user plane, anchor point for inter-/inter-radio access technology (RAT) mobility (when applicable), and the like, for the core network and for receiving device 305.

Generally, the receiving device 305 illustrates one non-limiting example of a functional split architecture that may be employed in a wireless device and used for performing wireless communications over wireless communication system 300. In one example, receiving device 305 may be an example of a base station that is configured using a central unit/distributed unit functional split. However, it is to be understood that receiving device 305 may also be implemented (at least in some aspects) as a UE configured such that one or more protocol layer functions are performed in different components, processes, functionalities, and the like, within the UE.

Generally, receiving device 305 may include a central unit, which is illustrated as central unit 320 that manages aspects in the control plane (CU-CP) and a central unit 325 that manages aspects in the user plane (CU-UP). Receiving device 305 may also include a distributed unit 350. When receiving device 305 is implemented as a base station, the functional split between the central unit and the distributed unit 350 may be implemented as a split between an access node controller and a smart radio head. However, it is to be understood that the functional split configuration illustrated in receiving device 305 is only one example of how the functional split may be implemented, but that other functional split configurations may also be supported.

In the control plane, the central unit 320 may implement aspects of RRC layer 330 and PDCP layer 335. In the user plane, central unit 325 may implement aspects of service data adaptation protocol (SDAP) layer 340 and PDCP layer 345. The central unit 320 and the central unit 325 may interface or otherwise communicate with each other via an E1 interface. The distributed unit 350 may implement aspects of an RLC layer 355, a MAC layer 360, and the physical layer 365.

As discussed herein, integrity protection of the data packet using conventional techniques may be problematic in a functional split architecture in some cases because RRC layer 330 and MAC layer 360 each may have inputs that are used for integrity protection, but are unknown to the other layer. Accordingly, aspects of the described techniques provide a mechanism that improves integrity protection of the data received in a message in a functional split architecture.

In some aspects, a mechanism may include the central unit verifying the integrity of the data. For example, the central unit (e.g., RRC layer 330 of the central unit 320 in the control plane) may receive information for which it can identify the hash that is calculated based at least in part on the data portion of a message received by the distributed unit 350 (e.g., in the MAC layer 360) of the receiving device 305. In one example, the distributed unit 350 may calculate the hash and transmit or otherwise provide the hash to the central unit, e.g., using the F1-C or a W1 interface. In some aspects, the distributed unit 350 may also transmit or otherwise provide the RRC message (e.g., the control portion of the message) as well as the uplink data payload (e.g., the data portion of the message) to the central unit. In this example, the central unit confirms or otherwise verifies the integrity of the data portion of the message and establishes user plane tunnel(s) for forwarding the data from the distributed unit 350 after processing. For example, central unit 320 may coordinate via the E1 interface with central unit 325 to establish one or more user plane tunnels between central unit 325 and distributed unit 350 in order to forward the data portion of the message after processing at the distributed unit 350, e.g., after processing by the MAC layer 360 and the RLC layer 355.

In another example, distributed unit 350 may transmit or otherwise provide the contents of the data portion of the message (e.g., EDT uplink data) to the central unit (e.g., to central unit 320) as a bit string (or a byte string or an equivalent), while keeping a copy of the uplink data portion of the message at the distributed unit 350. In this example, the central unit may use the bit string (or byte string or equivalent) to compute the hash without interpretation, e.g., without decoding or otherwise interpreting the MAC SDU(s). The central unit may use the hash to confirm or otherwise verify the integrity of the data portion of the message and, once confirmed, establish the user plane tunnel(s) with the distributed unit 350 to forward the data portion of the message after processing at the distributed unit 350. The distributed unit 350 may forward the data portion of the message to the PDCP layer 345 in the user plane of central unit 325, e.g., the distributed unit 350 may demultiplex and forward the data in MAC SDU(s) to a PDCP entity (or entities).

In some aspects, the central unit may confirm the integrity of the data portion of the message by using the hash (that is calculated based on the data portion of the message) along with other inputs to determine a calculated control information (e.g., a calculated sRMAC-I) for the message. The central unit may then compare the calculated control information to control information carried or otherwise conveyed in the message, e.g., to a ShortResumeMAC-I message authentication token carried in the control portion of the message. As the control information is calculated by the transmitting device using a hash of the data carried in the message, the integrity of the data portion message can be confirmed or otherwise verified if the calculated control information matches the control information carried in the message.

As discussed, the central unit may use the hash and other inputs to calculate the control information (e.g., the ShortResumeMAC-I message authentication token) during data integrity verification. For example, the other inputs that the central unit may use may include, but are not limited to, a key (e.g., such as a KRRont, that is common to the central unit and the distributed unit 350), a source physical cell identifier (PCI), a source cellular radio network temporary identifier (C-RNTI), a target cell identifier, a resume constant value, and the like.

In at least some examples, receiving device 305 may be a target base station that may coordinate with a source base station during data integrity verification. For example, the receiving device 305 may transmit or otherwise provide the hash calculated based at least in part on the data and/or the control information (e.g., the sRMAC-I) to the source base station that is associated with the device transmitting the message (e.g., to the source base station of a UE). The source base station (e.g., a central unit function implemented at the source base station) may perform the data integrity verification using the provided hash and/or control information, and then may respond by transmitting or otherwise providing a signal to the receiving device 305 (e.g., the target base station) confirming the integrity of the data portion of the message. During this exchange, the source base station may also transmit or otherwise provide context information for the UE, such as security context information, to the receiving device 305. In some aspects, this may include the source base station deriving a new key for the UE, and providing the key to the receiving device 305. Receiving device 305 may use this security context information to establish a security protocol with the UE (or whichever device transmits the message). In some aspects, the source base station and the target base station may be implemented as separate devices that communicate via one or more wireless and/or backhaul interfaces. In other aspects, the source base station and target base station may be implemented in a single device, where the source base station and the target base station are implemented as different sub-components, processes, functionalities, and the like, on the single device.

In another option, the distributed unit 350 may perform data integrity verification. For example, the distributed unit 350 may determine or otherwise identify control information from the control portion of the message. In one example, this may include distributed unit 350 verifying the integrity of the data carried in the message by performing a deep packet inspection. For example, distributed unit 350 may decode at least a portion of the message (e.g., the RRC message part of the MAC PDU) to identify or otherwise detect the control information (e.g., the sRMAC-I message authentication token) carried or otherwise conveyed in the message. The distributed unit 350 may calculate or otherwise determine the hash based on the data portion of the message, and use the hash (along with other inputs) to calculate the control information (e.g., a calculated sRMAC-I message authentication token). The distributed unit may confirm or otherwise verify the integrity of the data portion of the message by comparing the calculated control information with the control information recovered from the control portion of the message. Once data integrity is confirmed, distributed unit 350 may establish one or more tunnels or may identify one or more tunnels that have been previously established (control plane tunnels and/or user plane tunnels) with the central unit (e.g., with one or more central units, such as central unit 320 in the control plane and central unit 325 in the user plane) to forward the message after processing. For example, distributed unit 350 may forward the control portion of the message (e.g., the RRC message) to the central unit 320 in the control plane and forward the data portion of the message (e.g., the EDT uplink data) to the central unit 325 in the user plane.

In some aspects, distributed unit 350 may utilize a key during data integrity verification. For example, distributed unit 350 may receive or otherwise obtain the key from the central unit, and use the key (along with the hash and other inputs) when calculating the control information to use for data integrity verification. In some aspects, the key may be common key used (or known) by the central unit and the distributed unit 350 (e.g., K_{RRcint}). In other examples, an additional key (e.g., K_{eNB}/K_{gNB}) may be derived (e.g., at the central unit and provided to the distributed unit) that is unique to the distributed unit 350.

As discussed, the distributed unit 350 may use the hash and other inputs to calculate the control information (e.g., the ShortResumeMAC-I message authentication token) during data integrity verification. For example, the other inputs that the distributed unit 350 may use may include, but are not limited to, a key (e.g., such as a KRRont), a source-PCI, a source C-RNTI, a target cell identifier, a resume constant value, and the like.

In another example, the distributed unit may verify the data integrity without performing a deep packet inspection of the message. For example, the distributed unit 350 may determine or otherwise identify the control information from the message by transmitting or otherwise providing the control portion of the message (e.g., the RRC message) to the central unit (e.g., to central unit 320 in the control plane). In this example, the central unit may decode, identify, or otherwise detect the control information (e.g., the sRMAC-I message authentication token) from the control portion and transmit or otherwise provide a signal to the distributed unit 350 identifying the control information. Distributed unit 350 may then calculate or otherwise determine the hash based on the data portion of the message, and may verify the integrity of the data portion based on the control information. For example, the distributed unit 350 may calculate control information and compare the calculated control information (e.g., calculated sRMAC-I) to the control information received from the central unit to confirm or otherwise verify the integrity of the data portion of the message. As discussed, distributed unit 350 may utilize the hash and other inputs in determining the calculated control information.

As discussed herein, the distributed unit 350 may utilize a key when determining the calculated control information. The key may be common key for the distributed unit 350 and the central unit (e.g., K_{RRcint}) and/or may use a key that is generated specifically for, and unique to, the distributed unit 350 (e.g., K_{eNB}/K_{gNB}).

Once the distributed unit 350 confirms or otherwise verifies the integrity of the data portion of the message, one or more tunnels may be established to forward the message after processing by the distributed unit 350. For example, one or more user plane tunnels may be established between the distributed unit 350 and central unit 325 in the user plane, and one or more control plane tunnels may be established between the distributed unit 350 and central unit 320 in the control plane. Accordingly, distributed unit 350 may forward the control portion of the message to the central unit 320 via a control plane tunnel and the data portion of the message to the central unit 325 via the user plane tunnel. The central unit may process the message, and then forward message on to one or more core network functions.

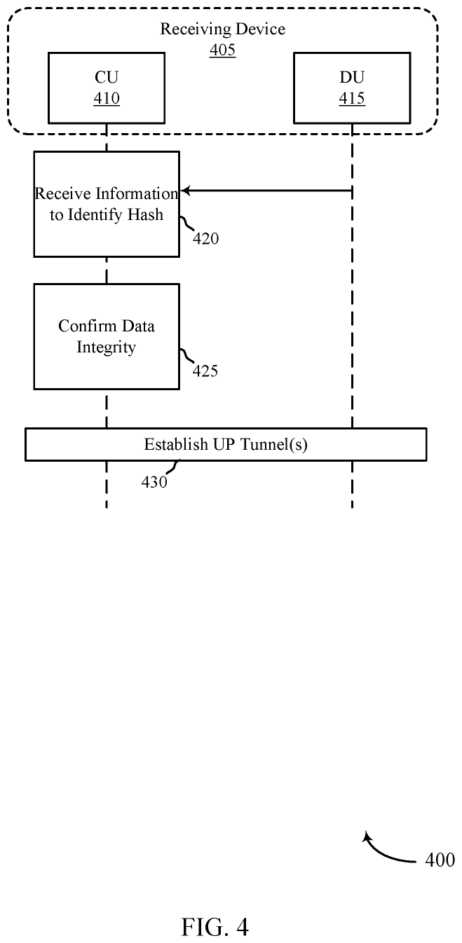

FIG. 4 illustrates an example of a process 400 that provides support for early data transmission with a central unit/distributed unit functional split in accordance with aspects of the present disclosure. In some examples, process 400 may implement aspects of wireless communication systems 100 and/or 300, and/or protocol stack 200. Aspects of process 400 may be implemented by a receiving device 405, which may be example of a base station and/or UE as described herein. In some aspects, the receiving device 405 may have a functional split architecture where the performance of different functions is split between central unit 410 and distributed unit 415.

At 420, central unit 410 may receive from distributed unit 415 information from which the central unit is able to identify a hash calculated based at least in part on the data portion of a message received by distributed unit 415 of receiving device 405. In some aspects, this may include the distributed unit 415 calculating the hash and including information identifying the hash to the central unit 410. In some aspects, this may include the distributed unit 415 transmitting or otherwise providing a bit string (or byte string) of the data portion of the message, with the central unit 410 calculating the hash based at least in part on the bit string (or byte string). In some aspects, central unit 410 may also receive (e.g., at a control plane function and/or a user plane function of the central unit 410) the control portion and/or the data portion a message, respectively, from the distributed unit 415. The central unit 410 may identify or otherwise determine the control information (e.g., the sRMAC-I message authentication token) from the control portion of the message.

At 425, central unit 410 may confirm an integrity of the data portion of the message based at least in part on the hash. In some aspects, this may include central unit 410 confirming that a first control information from a control portion of the message matches a second control information calculated based at least in part on the hash. For example, central unit 410 may confirm that a calculated (based on the hash and other inputs) sRMAC-I message authentication token (the second control information) matches the sRMAC-I message authentication token carried in the control portion of the message (the first control information). In some aspects, central unit 410 may use the hash along with other inputs to confirm the integrity of the data portion of the message. Examples of the other inputs may include, but are not limited to, an RRC key (e.g., KRRont), a PCI, a source base station C-RNTI, a resume constant value, a cell identifier for the receiving device 405, and the like.

In some aspects, the receiving device 405 may be a target base station and may confirm the integrity of the data portion of the message by providing the hash and/or the control information from the control portion of the message to a source base station. Receiving device 405 may receive a signal from the source base station confirming the integrity of the data portion of the message. In some aspects, the receiving device 405 may also receive a security context for the wireless device transmitting the message from the source base station (e.g., a UE). Receiving device 405 may establish a security protocol with the wireless device using the security context.

At 430, central unit 410 may authorize, based at least in part on confirmation of the integrity of the data portion of the message, one or more user plane tunnels with the distributed unit 415 to forward the data portion of the message from the distributed unit to the central unit after processing at the distributed unit 415. In some cases, authorizing the one or more user plane tunnels may include establishing the one or more user plane tunnels. In some other cases, authorizing the one or more user plane tunnels may include identifying the one or more user plane tunnels which have been previously established. Central unit 410 may transmit, provide, or otherwise forward the data portion of the message to a network entity (e.g., a UPF) after processing at the central unit 410.

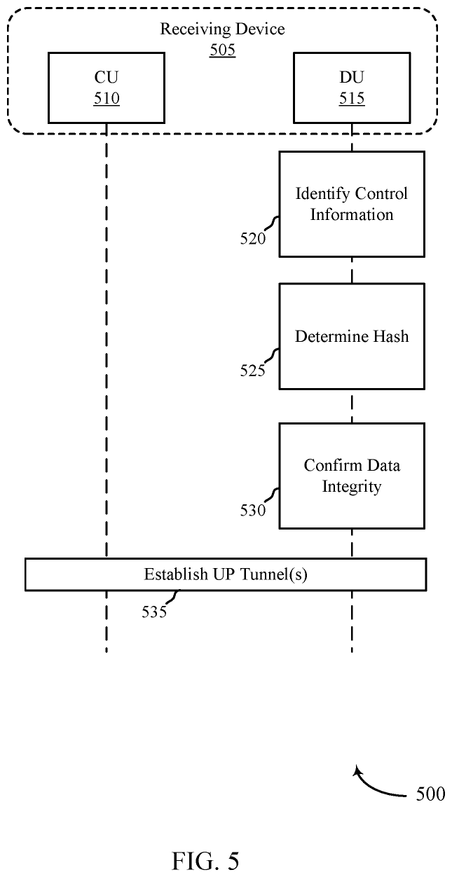

FIG. 5 illustrates an example of a process 500 that provides support for early data transmission with a central unit/distributed unit functional split in accordance with aspects of the present disclosure. In some examples, process 500 may implement aspects of wireless communication systems 100 and/or 300, and/or protocol stack 200. Aspects of process 500 may be implemented by a receiving device 505, which may be an example of a base station and/or UE as described herein. In some aspects, the receiving device 505 may have a functional split architecture where the performance of different functions is split between central unit 510 and distributed unit 515.

At 520, distributed unit 515 may determine or otherwise identify control information from a control portion of the message received by the distributed unit 515 of receiving device 505. In some aspects, this may include distributed unit 515 performing a deep packet inspection of the control portion of the message (e.g., decoding the control portion of the message) to identify the control information. In other aspects, this may include distributed unit 515 transmitting or otherwise providing the control portion of the message to central unit 510, with central unit 510 recovering the control information from the control portion of the message. Central unit 510 may then transmit or otherwise provide a signal to distributed unit 515 identifying the control information.

At 525, distributed unit 515 may calculate or otherwise determine a hash that is calculated based at least in part on a data portion of the message.

At 530, distributed unit 515 may confirm the integrity of the data portion of the message based at least in part on the hash and the control information. In some aspects, this may include distributed unit 515 receiving a key from central unit 510. Distributed unit 515 may use the key and the hash (along with other inputs) to verify the control information from the control portion of the message. For example, distributed unit 515 may use the key, the hash, and other inputs, to calculate control information and to determine whether the control information carried in the message matches the calculated control information. In some aspects, the control information and/or the calculated control information may be sRMAC-I message authentication tokens. In some aspects, the key may be a common key with respect to the central unit 510 and the distributed unit 515. In some aspects, the key may be calculated by the central unit 510 and is unique to the distributed unit 515.

In some aspects, receiving device 505 may be a target base station. In this example, distributed unit 515 may confirm the integrity of a data portion of the message by transmitting or otherwise providing the hash and the control information from the control portion of the message to a source base station. Distributed unit 515 may transmit or otherwise provide the hash and the control information to the source base station via the central unit 510. The source base station may use the control information and/or the hash to confirm the integrity of the data portion of the message and to transmit or otherwise provide a signal to the central unit 510 confirming the integrity of the data portion of the message. Central unit 510 may then transmit or otherwise provide data integrity confirmation information to distributed unit 515.

At 535, distributed unit 515 may authorize one or more user plane tunnels with central unit 510 to forward the data portion of the message after processing and based at least in part on the data integrity confirmation. In some cases, authorizing the one or more user plane tunnels may include establishing the one or more user plane tunnels. In some other cases, authorizing the one or more user plane tunnels may include identifying the one or more user plane tunnels which have been previously established. In some aspects, this may include distributed unit 515 forwarding the data portion of the message to central unit 510 and/or a network entity after processing.

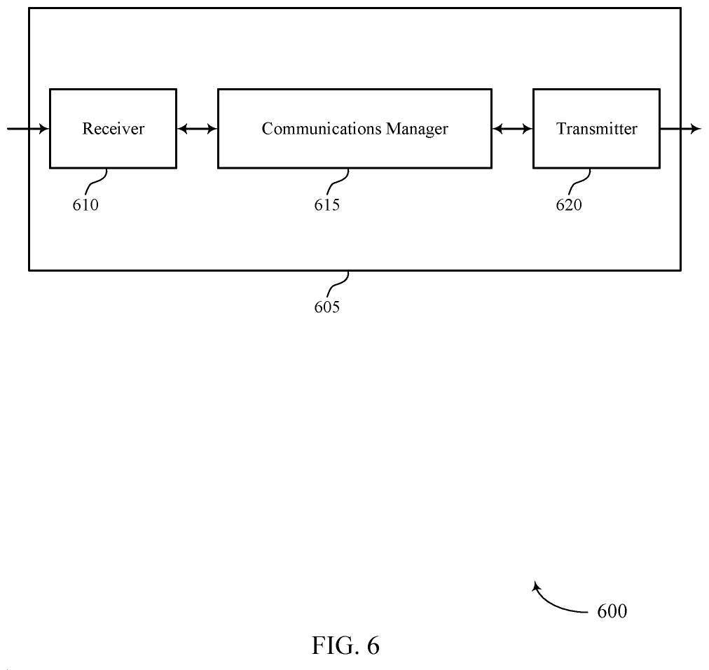

FIG. 6 shows a block diagram 600 of a device 605 that provides support for early data transmission with a central unit/distributed unit functional split in accordance with aspects of the present disclosure. The device 605 may be an example of aspects of a UE 115 or base station 105 as described herein. The device 605 may include a receiver 610, a communications manager 615, and a transmitter 620. The device 605 may also include a processor. Each of these components may be in communication with one another (e.g., via one or more buses).

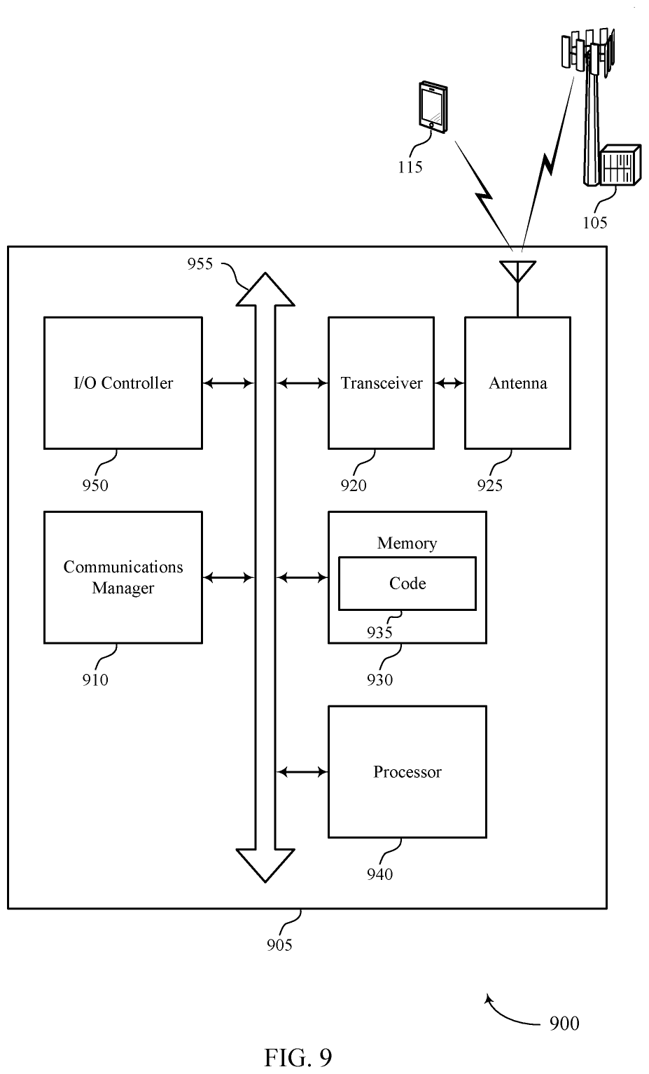

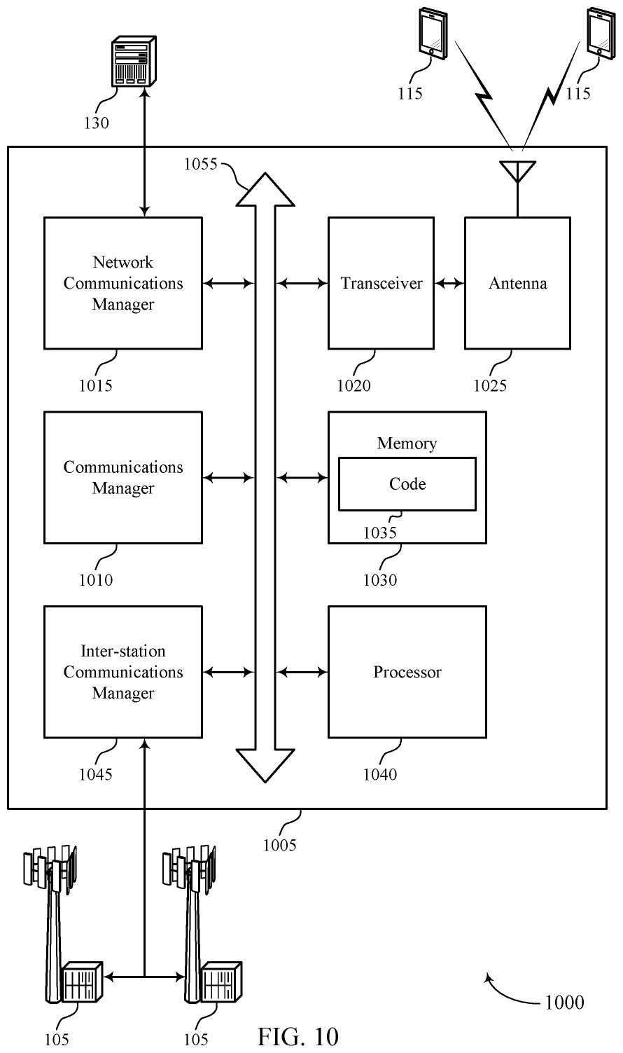

Receiver 610 may receive information such as packets, user data, or control information associated with various information channels (e.g., control channels, data channels, and information related to early data transmission with central unit/distributed unit functional split, etc.). Information may be passed on to other components of the device 605. The receiver 610 may be an example of aspects of the transceiver 920 or 1020 as described with reference to FIGS. 9 and 10. The receiver 610 may utilize a single antenna or a set of antennas.

The communications manager 615 may receive, at a central unit of the receiving device, information from which the central unit is able to identify a hash calculated based on a data portion of a message received by a distributed unit of the receiving device, confirm, at the central unit and based on the hash, an integrity of the data portion of the message, and authorize, based on the integrity confirmation, one or more user plane tunnels with the distributed unit to forward the data portion of the message from the distributed unit to the central unit after processing at the distributed unit.

The communications manager 615 may also receive a message at a distributed unit of the receiving device, identify, at a distributed unit of the receiving device, control information from a control portion of a message received by the distributed unit of the receiving device, determine a hash calculated based on a data portion of the message, confirm, based on the hash and the control information, an integrity of the data portion of the message, and authorize, based on the integrity confirmation, one or more user plane tunnels with one or more central units of the receiving device to forward the data portion of the message from the distributed unit to the central unit after processing at the distributed unit. The communications manager 615 may be an example of aspects of the communications manager 910 or 1010 as described herein.

The communications manager 615, or its sub-components, may be implemented in hardware, code (e.g., software or firmware) executed by a processor, or any combination thereof. If implemented in code executed by a processor, the functions of the communications manager 615, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 615, or its sub-components, may be physically located at various positions, including being distributed such that portions of functions are implemented at different physical locations by one or more physical components. In some examples, the communications manager 615, or its sub-components, may be a separate and distinct component in accordance with various aspects of the present disclosure. In some examples, the communications manager 615, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

Transmitter 620 may transmit signals generated by other components of the device 605. In some examples, the transmitter 620 may be collocated with a receiver 610 in a transceiver module. For example, the transmitter 620 may be an example of aspects of the transceiver 920 or 1020 as described with reference to FIGS. 9 and 10. The transmitter 620 may utilize a single antenna or a set of antennas.

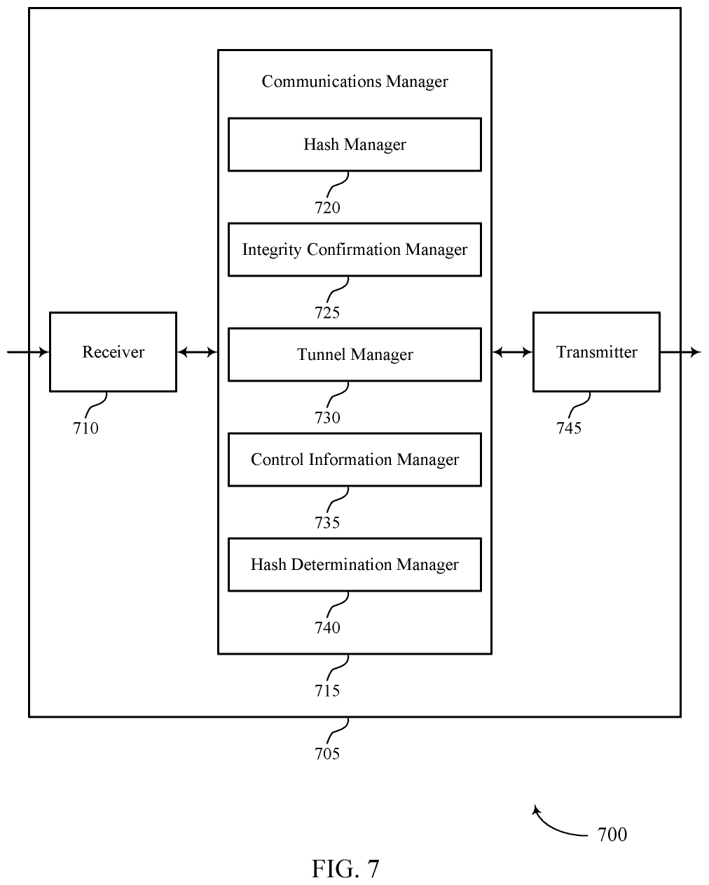

FIG. 7 shows a block diagram 700 of a device 705 that provides support for early data transmission with a central unit/distributed unit functional split in accordance with aspects of the present disclosure. The device 705 may be an example of aspects of a device 605, a UE 115, or a base station 105 as described herein. The device 705 may include a receiver 710, a communications manager 715, and a transmitter 745. The device 705 may also include a processor. Each of these components may be in communication with one another (e.g., via one or more buses).

Receiver 710 may receive information such as packets, user data, or control information associated with various information channels (e.g., control channels, data channels, and information related to early data transmission with central unit/distributed unit functional split, etc.). Information may be passed on to other components of the device 705. The receiver 710 may be an example of aspects of the transceiver 920 or 1020 as described with reference to FIGS. 9 and 10. The receiver 710 may utilize a single antenna or a set of antennas.

The communications manager 715 may be an example of aspects of the communications manager 615 as described herein. The communications manager 715 may include a hash manager 720, an integrity confirmation manager 725, a tunnel manager 730, a control information manager 735, and a hash determination manager 740. The communications manager 715 may be an example of aspects of the communications manager 910 or 1010 as described herein.

The hash manager 720 may receive, at a central unit of the receiving device, information from which the central unit is able to identify a hash calculated based on a data portion of a message received by a distributed unit of the receiving device.

The integrity confirmation manager 725 may confirm, at the central unit and based on the hash, an integrity of the data portion of the message.

The tunnel manager 730 may authorize, based on the integrity confirmation, one or more user plane tunnels with the distributed unit to forward the data portion of the message from the distributed unit to the central unit after processing at the distributed unit. The tunnel manager 730 may establish one or more user plane tunnels and/or may identify one or more previously established user plane tunnels.

The control information manager 735 may identify, at a distributed unit of the receiving device, control information from a control portion of a message received by the distributed unit of the receiving device.

The hash determination manager 740 may determine a hash calculated based on a data portion of the message.

The integrity confirmation manager 725 may confirm, based on the hash and the control information, an integrity of the data portion of the message.

The tunnel manager 730 may authorize, based on the integrity confirmation, one or more user plane tunnels with one or more central units of the receiving device to forward the data portion of the message from the distributed unit to the central unit after processing at the distributed unit.

Transmitter 745 may transmit signals generated by other components of the device 705. In some examples, the transmitter 745 may be collocated with a receiver 710 in a transceiver module. For example, the transmitter 745 may be an example of aspects of the transceiver 920 or 1020 as described with reference to FIGS. 9 and 10. The transmitter 745 may utilize a single antenna or a set of antennas.

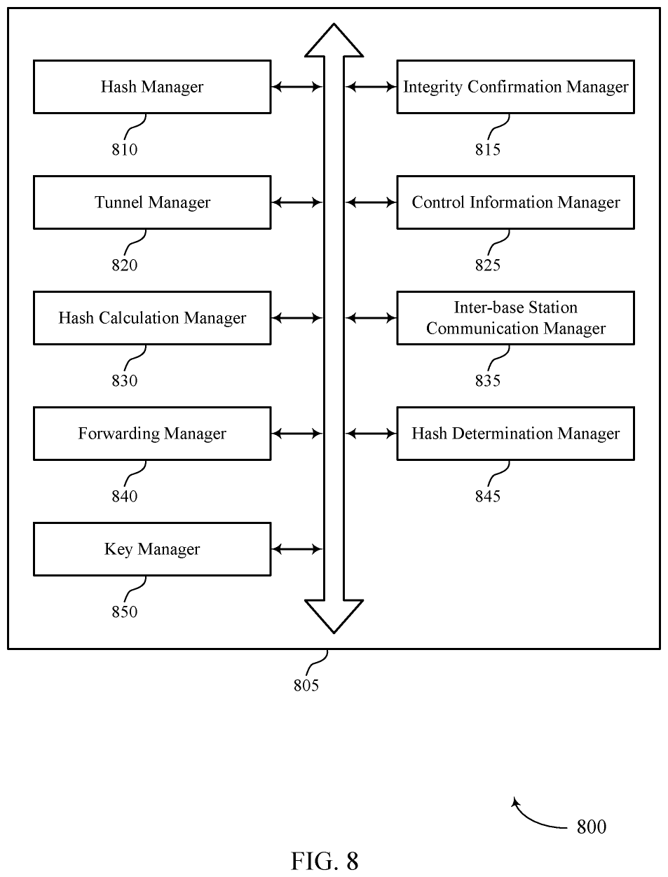

FIG. 8 shows a block diagram 800 of a communications manager 805 that provides support for early data transmission with a central unit/distributed unit functional split in accordance with aspects of the present disclosure. The communications manager 805 may be an example of aspects of a communications manager 615, a communications manager 715, or a communications manager 910 described herein. The communications manager 805 may include a hash manager 810, an integrity confirmation manager 815, a tunnel manager 820, a control information manager 825, a hash calculation manager 830, an inter-base station communication manager 835, a forwarding manager 840, a hash determination manager 845, and a key manager 850. Each of these modules may communicate, directly or indirectly, with one another (e.g., via one or more buses).

The hash manager 810 may receive, at a central unit of the receiving device, information from which the central unit is able to identify a hash calculated based on a data portion of a message received by a distributed unit of the receiving device. In some cases, the information identifies the hash calculated by the distributed unit.

The integrity confirmation manager 815 may confirm, at the central unit and based on the hash, an integrity of the data portion of the message. In some examples, the integrity confirmation manager 815 may confirm, based on the hash and the control information, an integrity of the data portion of the message. In some examples, the integrity confirmation manager 815 may identify at least one of a RRC key, a PCI, a source base station C-RNTI, a resume constant value, a cell identifier for the receiving device, or a combination thereof, used for confirming the integrity of the data portion.

In some examples, the integrity confirmation manager 815 may confirm that the control information from the control portion of the message matches a calculated control information, the calculated control information being calculated based on the hash. In some examples, the integrity confirmation manager 815 may identify at least one of a RRC key, a PCI, a source base station C-RNTI, a resume constant value, a cell identifier for the receiving device, or a combination thereof, used for confirming the integrity of the data portion. In some cases, the control information and the calculated control information include a ShortResumeMAC-I message authentication token.

The tunnel manager 820 may authorize, based on the integrity confirmation, one or more user plane tunnels with the distributed unit to forward the data portion of the message from the distributed unit to the central unit after processing at the distributed unit.

In some examples, the tunnel manager 820 may authorize, based on the integrity confirmation, one or more user plane tunnels with one or more central units of the receiving device to forward the data portion of the message from the distributed unit to the central unit after processing at the distributed unit.

The control information manager 825 may receive a message at a distributed unit of the receiving device, identify, at a distributed unit of the receiving device, control information from a control portion of a message received by the distributed unit of the receiving device. In some examples, the control information manager 825 may confirm that a first control information from a control portion of the message matches a second control information calculated based on the hash. In some examples, the control information manager 825 may decode the control portion of the message. In some examples, the control information manager 825 may transmit the control portion of the message to the central unit. In some examples, the control information manager 825 may receive a signal from the central unit identifying the control information. In some cases, the first and second control information include a ShortResumeMAC-I message authentication token.

The hash determination manager 845 may determine a hash calculated based on a data portion of the message.

The hash calculation manager 830 may calculate the hash based on the bit string. In some examples, the hash calculation manager 830 may receive a control portion and the data portion of the message from the distributed unit. In some examples, the hash calculation manager 830 may identify a control information from the control portion of the message, where the integrity of the data portion is confirmed based on the control information. In some cases, the control portion and the data portion of the message are received at a control plane function of the central unit.

The inter-base station communication manager 835 may provide, to a source base station associated with a wireless device transmitting the message, the hash and a control information from a control portion of the message. In some examples, the inter-base station communication manager 835 may receive a signal from the source base station confirming the integrity of the data portion of the message. In some examples, the inter-base station communication manager 835 may receive a security context for the wireless device from the source base station. In some examples, the inter-base station communication manager 835 may establish a security protocol with the wireless device based on the security context.

In some examples, the inter-base station communication manager 835 may provide, from the central unit and to a source base station associated with a wireless device transmitting the message, the hash and the control information from the control portion of the message. In some examples, the inter-base station communication manager 835 may receive, at the central unit and from the source base station, a signal confirming the integrity of the data portion of the message.

The forwarding manager 840 may forward the data portion of the message to a network entity after processing at the central unit. In some examples, the forwarding manager 840 may forward the data portion of the message to at least one of the one or more central units, a network entity, or a combination thereof, after processing at the distributed unit.

The key manager 850 may receive, from the central unit of the receiving device, a key. In some examples, the key manager 850 may use the key and the hash to verify the control information from the control portion of the message, where verifying the control information confirms the integrity of the data portion of the message. In some cases, the key is calculated by the central unit and is unique to the distributed unit. In some cases, the key is a source base station key that is common to the central unit and the distributed unit.

FIG. 9 shows a diagram of a system 900 including a device 905 that provides support for early data transmission with a central unit/distributed unit functional split in accordance with aspects of the present disclosure. The device 905 may be an example of or include the components of device 605, device 705, or a UE 115 as described herein. The device 905 may include components for bi-directional voice and data communications including components for transmitting and receiving communications, including a communications manager 910, a transceiver 920, an antenna 925, memory 930, a processor 940, and an I/O controller 950. These components may be in electronic communication via one or more buses (e.g., bus 955).

The communications manager 910 may receive, at a central unit of the receiving device, information from which the central unit is able to identify a hash calculated based on a data portion of a message received by a distributed unit of the receiving device, confirm, at the central unit and based on the hash, an integrity of the data portion of the message, and authorize, based on the integrity confirmation, one or more user plane tunnels with the distributed unit to forward the data portion of the message from the distributed unit to the central unit after processing at the distributed unit. The communications manager 910 may also receive a message at a distributed unit of the receiving device, identify, at a distributed unit of the receiving device, control information from a control portion of a message received by the distributed unit of the receiving device, determine a hash calculated based on a data portion of the message, confirm, based on the hash and the control information, an integrity of the data portion of the message, and authorize, based on the integrity confirmation, one or more user plane tunnels with one or more central units of the receiving device to forward the data portion of the message from the distributed unit to the central unit after processing at the distributed unit.

Transceiver 920 may communicate bi-directionally, via one or more antennas, wired, or wireless links as described herein. For example, the transceiver 920 may represent a wireless transceiver and may communicate bi-directionally with another wireless transceiver. The transceiver 920 may also include a modem to modulate the packets and provide the modulated packets to the antennas for transmission, and to demodulate packets received from the antennas.

In some cases, the wireless device may include a single antenna 925. However, in some cases the device may have more than one antenna 925, which may be capable of concurrently transmitting or receiving multiple wireless transmissions.

The memory 930 may include RAM, ROM, or a combination thereof. The memory 930 may store computer-readable code 935 including instructions that, when executed by a processor (e.g., the processor 940) cause the device to perform various functions described herein. In some cases, the memory 930 may contain, among other things, a BIOS which may control basic hardware or software operation such as the interaction with peripheral components or devices.

The processor 940 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In other cases, a memory controller may be integrated into the processor 940. The processor 940 may be configured to execute computer-readable instructions stored in a memory (e.g., the memory 930) to cause the device 905 to perform various functions (e.g., functions or tasks supporting early data transmission with central unit/distributed unit functional split).

The I/O controller 950 may manage input and output signals for the device 905. The I/O controller 950 may also manage peripherals not integrated into the device 905. In some cases, the I/O controller 950 may represent a physical connection or port to an external peripheral. In some cases, the I/O controller 950 may utilize an operating system such as iOS®, ANDROID®, MS-DOS®, MS-WINDOWS®, OS/2®, UNIX®, LINUX®, or another known operating system. In other cases, the I/O controller 950 may represent or interact with a modem, a keyboard, a mouse, a touchscreen, or a similar device. In some cases, the I/O controller 950 may be implemented as part of a processor. In some cases, a user may interact with the device 905 via the I/O controller 950 or via hardware components controlled by the I/O controller 950.

The code 935 may include instructions to implement aspects of the present disclosure, including instructions to support wireless communications. The code 935 may be stored in a non-transitory computer-readable medium such as system memory or other type of memory. In some cases, the code 935 may not be directly executable by the processor 940 but may cause a computer (e.g., when compiled and executed) to perform functions described herein.

FIG. 10 shows a diagram of a system 1000 including a device 1005 that provides support for early data transmission with a central unit/distributed unit functional split in accordance with aspects of the present disclosure. The device 1005 may be an example of or include the components of device 605, device 705, or a base station 105 as described herein. The device 1005 may include components for bi-directional voice and data communications including components for transmitting and receiving communications, including a communications manager 1010, a network communications manager 1015, a transceiver 1020, an antenna 1025, memory 1030, a processor 1040, and an inter-station communications manager 1045. These components may be in electronic communication via one or more buses (e.g., bus 1055).

The communications manager 1010 may receive, at a central unit of the receiving device, information from which the central unit is able to identify a hash calculated based on a data portion of a message received by a distributed unit of the receiving device, confirm, at the central unit and based on the hash, an integrity of the data portion of the message, and authorize, based on the integrity confirmation, one or more user plane tunnels with the distributed unit to forward the data portion of the message from the distributed unit to the central unit after processing at the distributed unit. The communications manager 1010 may also receive a message at a distributed unit of the receiving device, identify, at a distributed unit of the receiving device, control information from a control portion of a message received by the distributed unit of the receiving device, determine a hash calculated based on a data portion of the message, confirm, based on the hash and the control information, an integrity of the data portion of the message, and authorize, based on the integrity confirmation, one or more user plane tunnels with one or more central units of the receiving device to forward the data portion of the message from the distributed unit to the central unit after processing at the distributed unit.

Network communications manager 1015 may manage communications with the core network (e.g., via one or more wired backhaul links). For example, the network communications manager 1015 may manage the transfer of data communications for client devices, such as one or more UEs 115.

Transceiver 1020 may communicate bi-directionally, via one or more antennas, wired, or wireless links as described herein. For example, the transceiver 1020 may represent a wireless transceiver and may communicate bi-directionally with another wireless transceiver. The transceiver 1020 may also include a modem to modulate the packets and provide the modulated packets to the antennas for transmission, and to demodulate packets received from the antennas.

In some cases, the wireless device may include a single antenna 1025. However, in some cases the device may have more than one antenna 1025, which may be capable of concurrently transmitting or receiving multiple wireless transmissions.

The memory 1030 may include RAM, ROM, or a combination thereof. The memory 1030 may store computer-readable code 1035 including instructions that, when executed by a processor (e.g., the processor 1040) cause the device to perform various functions described herein. In some cases, the memory 1030 may contain, among other things, a BIOS which may control basic hardware or software operation such as the interaction with peripheral components or devices.

The processor 1040 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting early data transmission with central unit/distributed unit functional split).

Inter-station communications manager 1045 may manage communications with other base station 105, and may include a controller or scheduler for controlling communications with UEs 115 in cooperation with other base stations 105. For example, the inter-station communications manager 1045 may coordinate scheduling for transmissions to UEs 115 for various interference mitigation techniques such as beamforming or joint transmission. In some examples, inter-station communications manager 1045 may provide an X2 interface within an LTE/LTE-A wireless communication network technology to provide communication between base stations 105.

The code 1035 may include instructions to implement aspects of the present disclosure, including instructions to support wireless communications. The code 1035 may be stored in a non-transitory computer-readable medium such as system memory or other type of memory. In some cases, the code 1035 may not be directly executable by the processor 1040 but may cause a computer (e.g., when compiled and executed) to perform functions described herein.

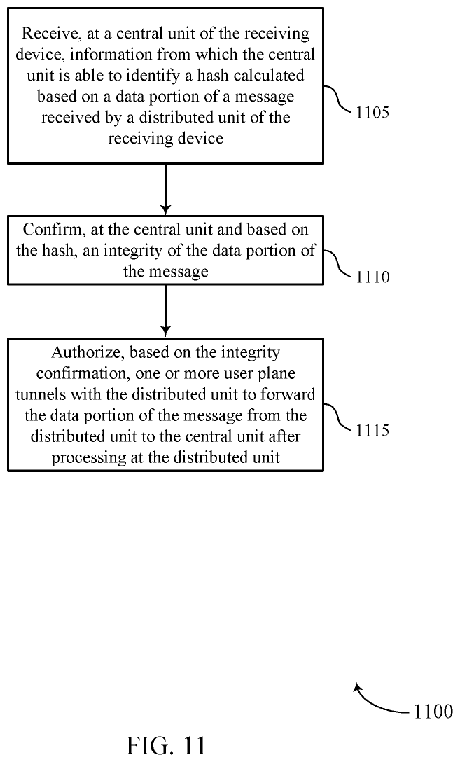

FIG. 11 shows a flowchart illustrating a method 1100 that provides support for early data transmission with a central unit/distributed unit functional split in accordance with aspects of the present disclosure. The operations of method 1100 may be implemented by a UE 115 or base station 105 or its components as described herein. For example, the operations of method 1100 may be performed by a communications manager as described with reference to FIGS. 6 through 10. In some examples, a UE or base station may execute a set of instructions to control the functional elements of the UE or base station to perform the functions described herein. Additionally or alternatively, a UE or base station may perform aspects of the functions described herein using special-purpose hardware.

At 1105, the UE or base station may receive, at a central unit of the receiving device, information from which the central unit is able to identify a hash calculated based on a data portion of a message received by a distributed unit of the receiving device. The operations of 1105 may be performed according to the methods described herein. In some examples, aspects of the operations of 1105 may be performed by a hash manager as described with reference to FIGS. 6 through 10.

At 1110, the UE or base station may confirm, at the central unit and based on the hash, an integrity of the data portion of the message. The operations of 1110 may be performed according to the methods described herein. In some examples, aspects of the operations of 1110 may be performed by an integrity confirmation manager as described with reference to FIGS. 6 through 10.

At 1115, the UE or base station may authorize, based on the integrity confirmation, one or more user plane tunnels with the distributed unit to forward the data portion of the message from the distributed unit to the central unit after processing at the distributed unit. The operations of 1115 may be performed according to the methods described herein. In some examples, aspects of the operations of 1115 may be performed by a tunnel manager as described with reference to FIGS. 6 through 10.

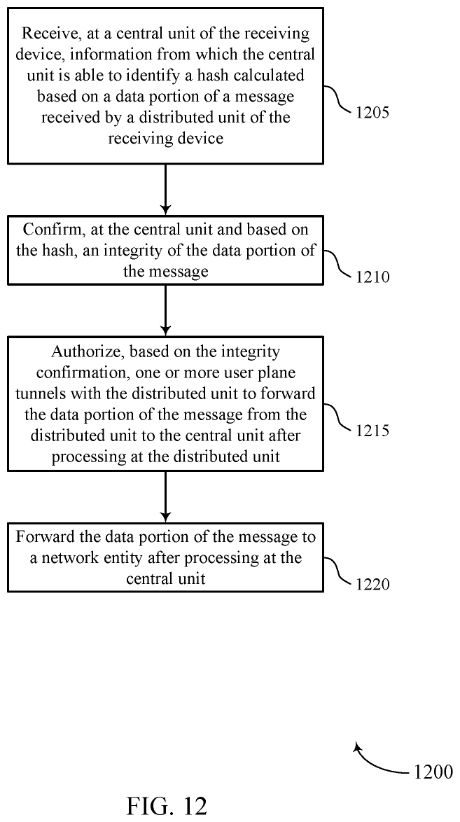

FIG. 12 shows a flowchart illustrating a method 1200 that provides support for early data transmission with a central unit/distributed unit functional split in accordance with aspects of the present disclosure. The operations of method 1200 may be implemented by a UE 115 or base station 105 or its components as described herein. For example, the operations of method 1200 may be performed by a communications manager as described with reference to FIGS. 6 through 10. In some examples, a UE or base station may execute a set of instructions to control the functional elements of the UE or base station to perform the functions described herein. Additionally or alternatively, a UE or base station may perform aspects of the functions described herein using special-purpose hardware.

At 1205, the UE or base station may receive, at a central unit of the receiving device, information from which the central unit is able to identify a hash calculated based on a data portion of a message received by a distributed unit of the receiving device. The operations of 1205 may be performed according to the methods described herein. In some examples, aspects of the operations of 1205 may be performed by a hash manager as described with reference to FIGS. 6 through 10.

At 1210, the UE or base station may confirm, at the central unit and based on the hash, an integrity of the data portion of the message. The operations of 1210 may be performed according to the methods described herein. In some examples, aspects of the operations of 1210 may be performed by an integrity confirmation manager as described with reference to FIGS. 6 through 10.

At 1215, the UE or base station may authorize, based on the integrity confirmation, one or more user plane tunnels with the distributed unit to forward the data portion of the message from the distributed unit to the central unit after processing at the distributed unit. The operations of 1215 may be performed according to the methods described herein. In some examples, aspects of the operations of 1215 may be performed by a tunnel manager as described with reference to FIGS. 6 through 10.

At 1220, the UE or base station may forward the data portion of the message to a network entity after processing at the central unit. The operations of 1220 may be performed according to the methods described herein. In some examples, aspects of the operations of 1220 may be performed by a forwarding manager as described with reference to FIGS. 6 through 10.

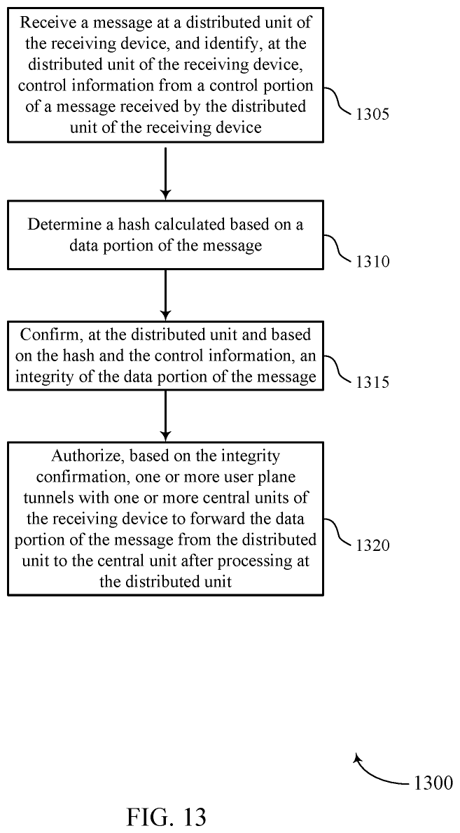

FIG. 13 shows a flowchart illustrating a method 1300 that provides support for early data transmission with a central unit/distributed unit functional split in accordance with aspects of the present disclosure. The operations of method 1300 may be implemented by a UE 115 or base station 105 or its components as described herein. For example, the operations of method 1300 may be performed by a communications manager as described with reference to FIGS. 6 through 10. In some examples, a UE or base station may execute a set of instructions to control the functional elements of the UE or base station to perform the functions described herein. Additionally or alternatively, a UE or base station may perform aspects of the functions described herein using special-purpose hardware.

At 1305, the UE or base station may receive a message at a distributed unit of the receiving device, and identify, at a distributed unit of the receiving device, control information from a control portion of a message received by the distributed unit of the receiving device. The operations of 1305 may be performed according to the methods described herein. In some examples, aspects of the operations of 1305 may be performed by a control information manager as described with reference to FIGS. 6 through 10.

At 1310, the UE or base station may determine a hash calculated based on a data portion of the message. The operations of 1310 may be performed according to the methods described herein. In some examples, aspects of the operations of 1310 may be performed by a hash determination manager as described with reference to FIGS. 6 through 10.

At 1315, the UE or base station may confirm, at the distributed unit and based on the hash and the control information, an integrity of the data portion of the message. The operations of 1315 may be performed according to the methods described herein. In some examples, aspects of the operations of 1315 may be performed by an integrity confirmation manager as described with reference to FIGS. 6 through 10.

At 1320, the UE or base station may authorize, based on the integrity confirmation, one or more user plane tunnels with one or more central units of the receiving device to forward the data portion of the message after processing at the distributed unit. The operations of 1320 may be performed according to the methods described herein. In some examples, aspects of the operations of 1320 may be performed by a tunnel manager as described with reference to FIGS. 6 through 10.

It should be noted that the methods described herein describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs with service subscriptions with the network provider. A small cell may be associated with a lower-powered base station, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations herein are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communications at a receiving device, comprising:
receiving, at a central unit of the receiving device, information from which the central unit is able to identify a hash calculated based at least in part on a data portion of a message received by a distributed unit of the receiving device;
confirming, at the central unit and based at least in part on the hash, an integrity of the data portion of the message; and
authorizing, based at least in part on the integrity confirmation, one or more user plane tunnels with the distributed unit to forward the data portion of the message from the distributed unit to the central unit after processing at the distributed unit.

2. The method of claim 1, wherein confirming the integrity of the data portion comprises:
confirming that a first control information from a control portion of the message matches a second control information calculated based at least in part on the hash.

3. The method of claim 2, wherein the first and second control information comprise a ShortResumeMAC-I message authentication token.

4. The method of claim 1, wherein authorizing the one or more user plane tunnels further comprises:
establishing the one or more user plane tunnels.

5. The method of claim 1, wherein authorizing the one or more user plane tunnels further comprises:
identifying the one or more user plane tunnels are previously established.

6. The method of claim 1, wherein the information identifies the hash calculated by the distributed unit.

7. The method of claim 1, wherein the information comprises a bit string of the data portion of the message, wherein confirming the integrity of the data portion comprises:
calculating the hash based at least in part on the bit string.

8. The method of claim 7, further comprising:
receiving a control portion and the data portion of the message from the distributed unit; and
identifying a control information from the control portion of the message, wherein the integrity of the data portion is confirmed based at least in part on the control information.

9. The method of claim 8, wherein the control portion and the data portion of the message are received at a control plane function of the central unit.

10. The method of claim 1, wherein the receiving device comprises a target base station, and confirming the integrity of the data portion of the message comprises:
providing, to a source base station associated with a wireless device transmitting the message, the hash and a control information from a control portion of the message; and
receiving a signal from the source base station confirming the integrity of the data portion of the message.

11. The method of claim 10, further comprising:
receiving a security context for the wireless device from the source base station; and
establishing a security protocol with the wireless device based at least in part on the security context.

12. The method of claim 1, further comprising:
forwarding the data portion of the message to a network entity after processing at the central unit.

13. The method of claim 1, further comprising:
identifying at least one of a radio resource control (RRC) key, a physical layer cell identifier (PCI), a source base station cellular radio network temporary identifier (C-RNTI), a resume constant value, a cell identifier for the receiving device, or a combination thereof, used for confirming the integrity of the data portion.

14. A method for wireless communications at a receiving device, comprising:
receiving a message at a distributed unit of the receiving device;
identifying, at the distributed unit of the receiving device, control information from a control portion of the message received by the distributed unit of the receiving device;
determining a hash calculated based at least in part on a data portion of the message;
confirming, at the distributed unit and based at least in part on the hash and the control information, an integrity of the data portion of the message; and
authorizing, based at least in part on the integrity confirmation, one or more user plane tunnels with one or more central units of the receiving device to forward the data portion of the message from the distributed unit to the central unit after processing at the distributed unit.

15. The method of claim 14, wherein confirming the integrity of the data message comprises:
receiving, from the central unit of the receiving device, a key; and
using the key and the hash to verify the control information from the control portion of the message, wherein verifying the control information confirms the integrity of the data portion of the message.

16. The method of claim 15, wherein the key is calculated by the central unit and is unique to the distributed unit.

17. The method of claim 15, wherein the key is a source base station key that is common to the central unit and the distributed unit.

18. The method of claim 14, wherein authorizing the one or more user plane tunnels further comprises:
establishing the one or more user plane tunnels.

19. The method of claim 14, wherein authorizing the one or more user plane tunnels further comprises:
identifying the one or more user plane tunnels are previously established.

20. The method of claim 14, wherein identifying the control information comprises:
decoding the control portion of the message.

21. The method of claim 14, wherein identifying the control information comprises:
transmitting the control portion of the message to the central unit; and
receiving a signal from the central unit identifying the control information.

22. The method of claim 14, wherein confirming the integrity of the data portion comprises:
confirming that the control information from the control portion of the message matches a calculated control information, the calculated control information being calculated based at least in part on the hash.

23. The method of claim 22, wherein the control information and the calculated control information comprise a ShortResumeMAC-I message authentication token.

24. The method of claim 14, wherein the receiving device comprises a target base station, and confirming the integrity of the data portion of the message comprises:
providing, from the central unit and to a source base station associated with a wireless device transmitting the message, the hash and the control information from the control portion of the message; and
receiving, at the central unit and from the source base station, a signal confirming the integrity of the data portion of the message.

25. The method of claim 14, further comprising:
forwarding the data portion of the message to at least one of the one or more central units, a network entity, or a combination thereof, after processing at the distributed unit.

26. The method of claim 14, further comprising:
identifying at least one of a radio resource control (RRC) key, a physical layer cell identifier (PCI), a source base station cellular radio network temporary identifier (C-RNTI), a resume constant value, a cell identifier for the receiving device, or a combination thereof, used for confirming the integrity of the data portion.

27. An apparatus for wireless communications at a receiving device, comprising:
a processor,
memory coupled with the processor; and
instructions stored in the memory and executable by the processor to cause the apparatus to:
receive, at a central unit of the receiving device, information from which the central unit is able to identify a hash calculated based at least in part on a data portion of a message received by a distributed unit of the receiving device;
confirm, at the central unit and based at least in part on the hash, an integrity of the data portion of the message; and
authorize, based at least in part on the integrity confirmation, one or more user plane tunnels with the distributed unit to forward the data portion of the message from the distributed unit to the central unit after processing at the distributed unit.

28. The apparatus of claim 27, wherein the instructions to confirm the integrity of the data portion are executable by the processor to cause the apparatus to:
confirm that a first control information from a control portion of the message matches a second control information calculated based at least in part on the hash.

29. The apparatus of claim 28, wherein the first and second control information comprise a ShortResumeMAC-I message authentication token.

30. The apparatus of claim 27, wherein the instructions to authorize the one or more user plane tunnels further are executable by the processor to cause the apparatus to:
establish the one or more user plane tunnels.

31. The apparatus of claim 27, wherein the instructions to authorize the one or more user plane tunnels further are executable by the processor to cause the apparatus to:
identify the one or more user plane tunnels are previously established.

32. The apparatus of claim 27, wherein the information identifies the hash calculated by the distributed unit.

33. The apparatus of claim 27, wherein the information comprises a bit string of the data portion of the message, comprises:
calculate the hash based at least in part on the bit string.

34. The apparatus of claim 33, wherein the instructions are further executable by the processor to cause the apparatus to:
receive a control portion and the data portion of the message from the distributed unit; and
identify a control information from the control portion of the message, wherein the integrity of the data portion is confirmed based at least in part on the control information.

35. The apparatus of claim 34, wherein the control portion and the data portion of the message are received at a control plane function of the central unit.

36. The apparatus of claim 27, wherein the receiving device comprises a target base station, and confirming the integrity of the data portion of the message comprises:
provide, to a source base station associated with a wireless device transmitting the message, the hash and a control information from a control portion of the message; and
receive a signal from the source base station confirming the integrity of the data portion of the message.

37. The apparatus of claim 36, wherein the instructions are further executable by the processor to cause the apparatus to:
receive a security context for the wireless device from the source base station; and
establish a security protocol with the wireless device based at least in part on the security context.

38. The apparatus of claim 27, wherein the instructions are further executable by the processor to cause the apparatus to:
forward the data portion of the message to a network entity after processing at the central unit.

39. The apparatus of claim 27, wherein the instructions are further executable by the processor to cause the apparatus to:
identify at least one of a radio resource control (RRC) key, a physical layer cell identifier (PCI), a source base station cellular radio network temporary identifier (C-RNTI), a resume constant value, a cell identifier for the receiving device, or a combination thereof, used for confirming the integrity of the data portion.

40. An apparatus for wireless communications at a receiving device, comprising:
a processor,
memory coupled with the processor; and
instructions stored in the memory and executable by the processor to cause the apparatus to:
receive a message at a distributed unit of the receiving device;
identify, at the distributed unit of the receiving device, control information from a control portion of the message received by the distributed unit of the receiving device;
determine a hash calculated based at least in part on a data portion of the message;
confirm, at the distributed unit and based at least in part on the hash and the control information, an integrity of the data portion of the message; and
authorize, based at least in part on the integrity confirmation, one or more user plane tunnels with one or more central units of the receiving device to forward the data portion of the message from the distributed unit to the central unit after processing at the distributed unit.

41. The apparatus of claim 40, wherein the instructions to confirm the integrity of the data message are executable by the processor to cause the apparatus to:
receive, from the central unit of the receiving device, a key; and
use the key and the hash to verify the control information from the control portion of the message, wherein verifying the control information confirms the integrity of the data portion of the message.

42. The apparatus of claim 41, wherein the key is calculated by the central unit and is unique to the distributed unit.

43. The apparatus of claim 41, wherein the key is a source base station key that is common to the central unit and the distributed unit.

44. The apparatus of claim 40, wherein the instructions to authorize the one or more user plane tunnels further are executable by the processor to cause the apparatus to:
establish the one or more user plane tunnels.

45. The apparatus of claim 40, wherein the instructions to authorize the one or more user plane tunnels further are executable by the processor to cause the apparatus to:
identify the one or more user plane tunnels are previously established.

46. The apparatus of claim 40, wherein the instructions to identify the control information are executable by the processor to cause the apparatus to:
decode the control portion of the message.

47. The apparatus of claim 40, wherein the instructions to identify the control information are executable by the processor to cause the apparatus to:
transmit the control portion of the message to the central unit; and
receive a signal from the central unit identifying the control information.

48. The apparatus of claim 40, wherein the instructions to confirm the integrity of the data portion are executable by the processor to cause the apparatus to:
confirm that the control information from the control portion of the message matches a calculated control information, the calculated control information being calculated based at least in part on the hash.

49. The apparatus of claim 48, wherein the control information and the calculated control information comprise a ShortResumeMAC-I message authentication token.

50. The apparatus of claim 40, wherein the receiving device comprises a target base station, and confirming the integrity of the data portion of the message comprises:
provide, from the central unit and to a source base station associated with a wireless device transmitting the message, the hash and the control information from the control portion of the message; and
receive, at the central unit and from the source base station, a signal confirming the integrity of the data portion of the message.

51. The apparatus of claim 40, wherein the instructions are further executable by the processor to cause the apparatus to:
forward the data portion of the message to at least one of the one or more central units, a network entity, or a combination thereof, after processing at the distributed unit.

52. The apparatus of claim 40, wherein the instructions are further executable by the processor to cause the apparatus to:
identify at least one of a radio resource control (RRC) key, a physical layer cell identifier (PCI), a source base station cellular radio network temporary identifier (C-RNTI), a resume constant value, a cell identifier for the receiving device, or a combination thereof, used for confirming the integrity of the data portion.

53. An apparatus for wireless communications at a receiving device, comprising:
means for receiving, at a central unit of the receiving device, information from which the central unit is able to identify a hash calculated based at least in part on a data portion of a message received by a distributed unit of the receiving device;
means for confirming, at the central unit and based at least in part on the hash, an integrity of the data portion of the message; and
means for authorizing, based at least in part on the integrity confirmation, one or more user plane tunnels with the distributed unit to forward the data portion of the message from the distributed unit to the central unit after processing at the distributed unit.

54. An apparatus for wireless communications at a receiving device, comprising:
means for receiving a message at a distributed unit of the receiving device;
means for identifying, at the distributed unit of the receiving device, control information from a control portion of the message received by the distributed unit of the receiving device;
means for determining a hash calculated based at least in part on a data portion of the message;
means for confirming, at the distributed unit and based at least in part on the hash and the control information, an integrity of the data portion of the message; and
means for authorizing, based at least in part on the integrity confirmation, one or more user plane tunnels with one or more central units of the receiving device to forward the data portion of the message from the distributed unit to the central unit after processing at the distributed unit.
